(19) United States
(12) Patent Application Publication
(10) Pub. No.: US 2009/0017903 A1
(43) Pub. Date: Jan. 15, 2009

(54) DEVICE CHECKING ILLUMINATION COLOR AND GAMING MACHINE

(75) Inventors: Masao Mizoguchi, Atsugi-shi (JP); Hidekazu Kato, Kawasaki-shi (JP); Toshiaki Shimizu, Yamato-shi (JP)

Correspondence Address: GLOBAL IP COUNSELORS, LLP, 1233 20TH STREET, NW, SUITE 700, WASHINGTON, DC, 20036-2680, US

(73) Assignee: Konami Gaming, Incorporated, Las Vegas, NV (US)

(21) Appl. No.: 12/212,288

(22) Filed: Sep. 17, 2008

Related U.S. Application Data
(63) Continuation-in-part of application No. 11/686,916, filed on Mar. 15, 2007.

(51) Int. Cl. A63F 9/24; H05B 37/02

(52) U.S. Cl. 463/20; 315/297

(57) ABSTRACT

In a gaming machine, a reel assembly includes a lighting unit, a lighting driver unit, and a color check unit, as well as a reel and a motor. The lighting unit emits colored rays to a symbol displayed on a visible region on a reel. The lighting driver unit adjusts driving currents for the lighting unit in accordance with a control signal. The color check unit generates an error signal when detecting that the level of any driving current falls outside a predetermined range. A game control unit conducts a game by randomly changing arrangements and colors of the visible symbols. A lighting control unit provides the control signal to the lighting driver unit. If receiving the error signal from the color check unit, the lighting control unit informs the game control unit of an error state of the lighting unit.

This application is a continuation-in-part of U.S. patent application Ser. No. 11/686,916 filed Mar. 15, 2007.

### BACKGROUND OF THE INVENTION

1. Field of the Invention

The present invention relates to a device for driving a lighting device, in particular, used to shed various colored light on a reel or wheel in a gaming machine such as a slot machine or a wheel-of-chance machine.

2. Background Information

Gaming machines such as slot machines, poker machines, fruit machines, and the like generally attract enormous popularity from players in casinos. These types of gaming machines display an arrangement of symbols on the front thereof, and change the types of symbols in the arrangement at random. A player guesses on which line of the arrangement, i.e., payline, a specific combination of symbols, i.e., a winning combination will appear, and then places a bet on the payline before the symbols are changed in the arrangement. If a winning combination appears on the payline on which the player has placed a bet, the player will win an amount of a payout that depends on the amount of the bet and the type of the winning combination.

These types of gaming machines are generally equipped with mechanical reels that are coaxially arranged and allowed to independently spin by means of respective motors. Symbols are permanently displayed on the circumferential surfaces on each reel in a predetermined order. The reels repeat spins and stop, and thereby change symbols placed at visible positions. Alternatively, the above types of gaming machines may be equipped with an electric display device on which a series of symbols arranged in graphic form, i.e., a video reel is displayed.

Gaming machines with wheels of chance also attract popularity from players in casinos. This type of gaming machines displays a ring of symbols on the front surface of a wheel of chance around an axis thereof. The gaming machine rotates the wheel to randomly change a symbol stopped at a specific position when the wheel will stop. Alternatively, the gaming machine may be equipped with a mechanical indicator rotatable around the periphery of the wheel, and rotate the indicator to randomly change a symbol that the stopped indicator will point to. In addition, the gaming machine may change brightness or color of symbols in turn or at random to randomly change the brightest symbol or a symbol illuminated with a specific color of light. A player wins a payout or a bonus depending on a symbol stopped at the specific position, a symbol that the stopped indicator will point to, or a symbol illuminated with specific brightness or color. Like a roulette game, the gaming machine may allow a player to place a bet on one or more symbols before a spin of the wheel or the indicator. If one of the symbols on which the player has placed a bet stops at the specific position, the stopped indicator points to one of the symbols, or one of the symbols is illuminated with specific brightness or color, the player will win an amount of a payout that depends on the amount of the bet.

In general, the chances of winning larger payouts can attract a larger number of players to gaming machines. A gaming machine with a mechanical reel or wheel of chance can however provide limited amounts of payouts, in contrast to a gaming machine with a video reel, since the number of symbols per reel or wheel is limited by the size of the reel or wheel and the size of a cabinet of the gaming machine. On the other hand, many players prefer simple three-dimensional motions of symbols caused by the spin of a mechanical reel and wheel to unpredictably extensive and complex changes in symbols on a video reel. Accordingly, a gaming machine with a mechanical reel or wheel is desired that can increase the variety of symbols so as to exceed the number thereof otherwise limited by the size of the reel or wheel and the size of a cabinet of the gaming machine.

There is a conventional gaming machine with mechanical reels that changes illumination colors or patterns of a symbol in order to increase the variety of symbols (e.g. U.S. Pat. Nos. 6,027,115 and 6,056,642). The gaming machine deals with a symbol illuminated with a different color or a different pattern as a different type of symbol. Accordingly, the number of symbol types per reel will be increased by the number of colors or patterns available times the actual number of symbols displayed on each reel. The wider variety of symbols allows the gaming machine to expand the range of odds in games, and in particular raise the upper limit of payouts, regardless of the sizes of the reel and a cabinet of the gaming machine. Thus, the gaming machine can attract a larger number of players to play games thereon.

In order to determine whether or not a game has been won by using a single symbol as different types depending on illumination colors or patterns, a gaming machine has to ensure exact consistency between illumination colors or patterns and symbol types. This requires accurate checks for consistency between desired illumination colors or patterns and actual ones. In particular, a gaming machine has to be able to perform the accurate checks quickly enough for spins of reels or a wheel. However, there is no known device that can check illumination colors or patterns at sufficiently high speed in a simple manner. Accordingly, there is no known gaming machine that can ensure exact consistency between illumination colors or patterns and symbol types in a clear and simple manner.

In view of the above, it will be apparent to those skilled in the art from this disclosure that there exists a need for an improved device, which can drive a lighting device to emit a colored ray of light and check consistency between desired and actual colors or patterns of the light at sufficiently high speed in an accurate and simple manner. This invention addresses this need in the art as well as other needs, which will become apparent to those skilled in the art from this disclosure.

### SUMMARY OF THE INVENTION

According to the invention, a device is provided, which comprises a lighting driver unit and a color check unit. The lighting driver unit is configured to allow a driving current to flow in an external lighting unit. Here, the lighting unit is configured to emit a colored ray of light in response to the driving current. The color check unit is configured to monitor the level of the driving current and generate an error signal when detecting that the level of the driving current falls outside a predetermined range.

The predetermined range is preferably determined so that an actual color or pattern of the ray matches with a target one when the level of the driving current falls within the predetermined range. Accordingly, the device generates the error signal when the actual color or pattern of the ray deviates from the target one. Since it is easy to check if the level of the driving current falls outside the predetermined range, the device can accurately check consistency between the target and actual color or pattern of the ray at sufficiently high speed. If the consistency is lost, the device can use the error signal to immediately notify a system equipped with the device of the loss of the consistency.

The device according to the invention can be used in control of various types of lighting devices. The device according to the invention is preferably installed in a gaming machine. In this case, for example, the gaming machine first determines a target illumination color or pattern to illuminate a visible region of a reel or wheel, depending on what an illumination color or pattern in the visible region should mean in a game, i.e., which symbol type a symbol illuminated with a color or pattern in the visible region is to be dealt with as. The gaming machine next causes the lighting driver unit to control the driving current flowing in a lighting unit to illuminate the visible region with the target illumination color or pattern. On the other hand, the color check unit monitors the level of the driving current, and generates an error signal when detecting the level of the driving current falls outside the predetermined range. Here, the predetermined range is to be determined so that an actual illumination color or pattern of the visible region matches with the target one when the level of the driving current falls within the predetermined range. Accordingly, the error signal indicates when the actual illumination color or pattern of the visible region deviates from the target one. In response to the error signal, the gaming machine can take appropriate steps to inform a player and/or an attendant of an error in the lighting unit. Thus, the gaming machine can immediately detect inconsistency between a symbol type to be represented in the visible region and an actual illumination color or pattern in the visible region, thereby ensuring exact consistency therebetween under normal conditions.

These and other objects, features, aspects and advantages of the invention will become apparent to those skilled in the art from the following detailed description, which, taken in conjunction with the annexed drawings, discloses a preferred embodiment of the invention.

### BRIEF DESCRIPTION OF THE DRAWINGS

Referring now to the attached drawings which form a part of this original disclosure:

FIG. 1 is a perspective view of the external appearance of a gaming machine according to the first embodiment of the invention;

FIG. 2 is a block diagram of the configuration of the gaming machine shown in FIG. 1;

FIG. 3 is a perspective view of a reel assembly according to the first embodiment of the invention;

FIG. 4 is an exploded perspective view of the reel assembly shown in FIG. 3;

FIG. 5 is a block diagram of the control system of the lighting unit included in the reel assembly shown in FIG. 3;

FIGS. 6A-6J are timing charts of signals used in the control system shown in FIG. 5.

FIG. 7 is a perspective view of the external appearance of a gaming machine according to the second embodiment of the invention;

FIG. 8 is a block diagram of the configuration of the gaming machine shown in FIG. 7;

FIG. 9 is an exploded perspective view of a wheel assembly of the gaming machine shown in FIG. 7 and whose operational steps are shown in FIG. 8;

FIG. 10 is a front view of the circuit board shown in FIG. 9;

FIG. 11 is a block diagram of the control system of the lighting unit included in the wheel assembly shown in FIG. 8;

FIGS. 12A-12J are timing charts of signals used in the control system shown in FIG. 11.

FIG. 13 is a perspective view of the external appearance of a gaming machine according to the third embodiment of the invention;

FIG. 14 is a block diagram of the configuration of the gaming machine shown in FIG. 13;

FIG. 15 is a perspective view of the external appearance of a gaming machine according to the fourth embodiment of the invention; and

FIG. 16 is a block diagram of the configuration of the gaming machine shown in FIG. 15.

### BEST MODE FOR CARRYING OUT THE INVENTION

Selected embodiments of the invention will now be explained with reference to the drawings. It will be apparent to those skilled in the art from this disclosure that the following descriptions of the embodiments of the invention are provided for illustration only and not for the purpose of limiting the invention as defined by the appended claims and their equivalents.

Devices according to the following embodiments of the invention are used in gaming machines, which are preferably of a standalone type installed in a casino. Alternatively, the gaming machines may be of a download or thin-client type controlled by a server through a LAN.

### The First Embodiment

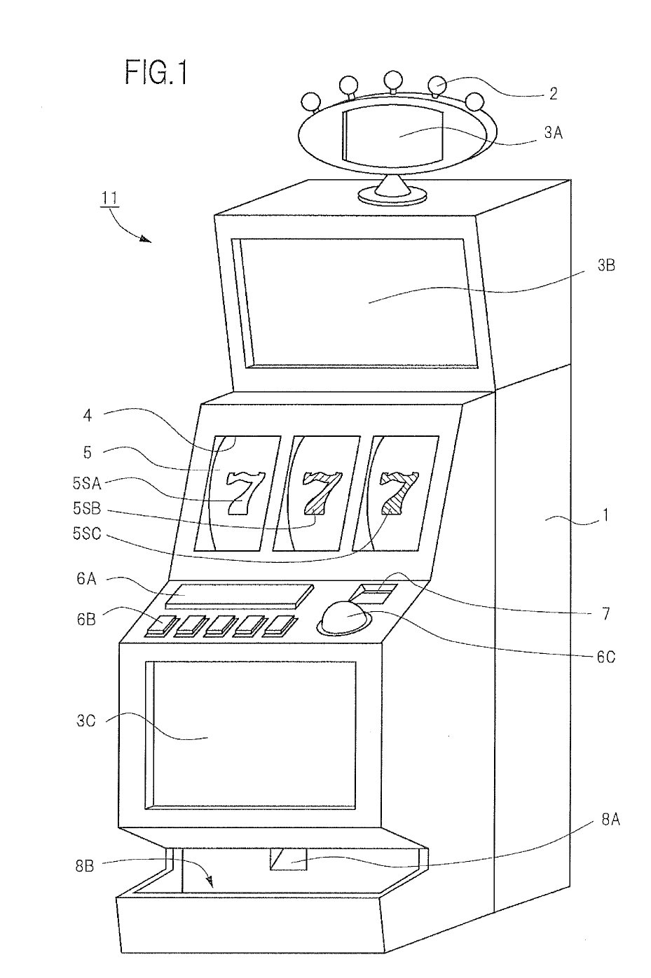

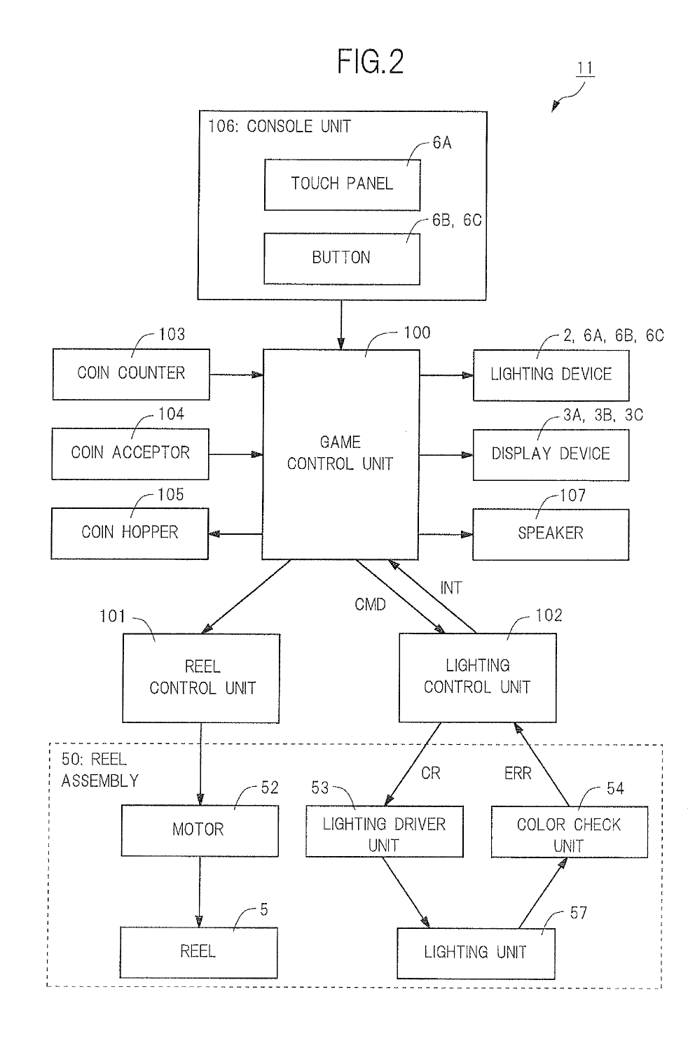

Referring to FIG. 1, a gaming machine 11 according to the first embodiment of the invention is preferably a stepper-reel slot machine. This gaming machine 11 includes a cabinet 1, lamps 2, display devices 3A, 3B, 3C, display windows 4, three reels 5, a touch panel 6A, operation buttons 6B, a spin button 6C, a coin/bill slot 7, a coin chute 8A, and a coin tray 8B, as components visible from the exterior. Referring to FIG. 2, this gaming machine 11 also includes a game control unit 100, a reel control unit 101, a lighting control unit 102, a coin counter 103, a coin acceptor 104, a coin hopper 105, a console unit 106, a speaker 107, and a reel assembly 50, as components mounted inside the cabinet 1 and invisible from the exterior.

The lamps 2 are illumination lighting devices mainly for use as decoration and visual effects in games; they can blink and/or change brightness and color in specific patterns. The lamps 2 may be mounted on, for example, the top of the cabinet 1 as shown in FIG. 1, and in addition, the front, sides, and rear of the cabinet 1.

The display devices 3A, 3B, and 3C each receive external image data, and reproduce images which correspond to the image data. The images include, for example, images for use in decoration such as the image of a logo of a game developer, images for use in advertisements, images for use in visual effects in games and the display of information about games such as pay tables, illustrations of game content, the amount of a bet, the number of credits available, and a jackpot meter.

The display windows 4 are comprised of a plurality of holes provided in front of the cabinet 1 as shown in FIG. 1. Each hole is preferably covered with glass. Behind the display windows 4, the three reels 5 are coaxially arranged. Here, the number of the reels 5 may be four or more. Each reel 5 is a mechanical reel rotatable around the center axis thereof. A region of the circumferential surface of each reel 5 is visible through each display window 4 from the front, i.e., the player's side of the cabinet 1. A plurality of symbols is displayed on the circumferential surface of each reel 5, and a few of the symbols 5SA, 5SB, 5SC are visible through each display window 4. The symbol 5SA, 5SB, 5SC may include a geometric figure, a mark, a character, a letter, or a number. Different symbols appear in each display window 4, depending on the rotation angle of each reel 5.

Referring to FIG. 2, each reel 5 is included in the reel assembly 50. The reel assembly 50 includes a motor 52, a lighting driver unit 53, a color check unit 54, and a plurality of lighting units 57, in addition to the reel 5.

The motor 52 is preferably a stepping motor having a shaft coupled to the center axis of the reel 5. The motor 52 controls the rotation angle and speed of the reel 5 under control of the reel control unit 101.

The lighting units 57 illuminate the visible regions of the circumferential surfaces of the reels 5 with colored rays of light. The lighting driver unit 53 allows a driving current to flow in each lighting unit 57 in accordance with control signals CR received from the lighting control unit 102, thereby changing illumination colors and/or patterns of each symbol 5SA, 5SB, 5SC, placed at the visible regions on the reels 5. The same symbols illuminated with different colors and/or patterns are dealt with as different symbol types. In FIG. 1, for example, the same “7” symbols 5SA, 5SB, 5SC with different colors are dealt with as different symbol types. Alternatively, different variation pattern in color, brightness, blinking frequency, or other attribute of light, may distinguish between the same “7” symbols 5SA, 5SB, 5SC as being different symbol types. Accordingly, the number of the symbol types visible on each reel 5 is several times as many as the number of the symbols actually displayed on the reel 5, depending on the number of the colors and/or patterns that the lighting unit 57 can express.

The color check unit 54 checks consistency between actual colors/patterns of the illuminated symbols and symbol types to be visible through the display windows 4. When detecting inconsistency therebetween, the color check unit 54 provides an error signal ERR to the lighting control unit 102. Detail will be described below.

Referring to FIG. 1 again, input devices such as the touch panel 6A, the operation buttons 6B, and the spin button 6C are mounted on the front of the cabinet 1, and connected to the console unit 106 shown in FIG. 2. The console unit 106 accepts various kinds of instructions from a player through the input devices 6A, 6B, 6C. The instructions in particular include a request for a game program selected by a player and an instruction from a player to change game status. The touch panel 6A preferably displays a keyboard image and a numeric keypad image thereon, thereby allowing a player to enter characters and numerals. The operation buttons 6B and the spin button 6C are lamp buttons, which include LEDs and light up when pushed. A player selectively pushes the operation buttons 6B, preferably in order to select paylines and the amount of a bet. A player pushes the spin button 8 in order to cue the reels 5 for the start of a spin.

Referring to FIG. 1 again, the coin/bill slot 7 allows a player to enter coins and bills thereinto. Referring to FIG. 2, the coin counter 103 counts the coins and bills, and the coin acceptor 104 validates the coins and bills. The total amount of the validated coins and bills are displayed, for example, on the middle display device 3B as credits available to the player. The coin hopper 105 stores a large number of coins as well as coins and bills entered into the coin/bill slot 7, and discharges coins equivalent to credits that a player has won on a game from the coin chute 8A into the coin tray 8B.

Referring to FIG. 2, the speaker 107 is installed inside the cabinet 1, and generates voice announcements and sound effects under control of the game control unit 100.

Referring to FIG. 2, the game control unit 100, the reel control unit 101, and the lighting control unit 102 are preferably comprised of a microcomputer including a CPU, a ROM, and a RAM. Alternatively, the three control units 100, 101, and 102 may be separately composed of distinct pieces of hardware.

The reel control unit 101 controls the motor 52 of each reel assembly 50 under control of the game control unit 100, thereby rotating the reel 5 at a desired speed and stopping it at a desired position.

The lighting control unit 102 receives a command CMD from the game control unit 100. The lighting control unit 102 then generates a control signal CR according to the command CMD, and provides the control signal CR to the lighting driver unit 53.

The game control unit 100 stores a game program. When receiving a cue for the start of a game from a player through the console unit 106, e.g., when the player enters coins/bills into the coin/bill slot 7, the game control unit 100 invokes the game program. After that, the game control unit 100 conducts the game according to the executed game program. In particular, the game control unit 100 controls other components installed on the gaming machine 11, depending on the game status as follows.

When a player enters coins/bills into the coin/bill slot 7, the game control unit 100 detects and accepts the coins/bills through the console unit 106, and then increases credits available to the player by the count provided by the coin counter 103. In parallel with that, the game control unit 100 starts to produce visual and sound effects by using the lighting devices 2, 6A, 6B, 6C, the display devices 3A, 3B, 3C, and the speaker 107.

When the player selects paylines and places a bet by using the touch panel 6A and/or the buttons 6B, the game control unit 100 identifies the paylines and the bet accepted by the console unit 106, then decreasing the available credits by the amount of the bet. The game control unit 100 further displays the amounts of the bet, the number of available credits, and the selected paylines on the display devices 3A, 3B, and/or 3C.

When the console unit 106 detects that the player has pushed the spin button 6C, the game control unit 100 then causes the reel control unit 101 to command the motor 52 of each reel assembly 50 to spin the reel 5. In synchronization with the spin, the game control unit 100 provides the lighting control unit 102 with commands CMD to control the lighting driver unit 53 of each reel assembly 50, thereby causing the lighting units 57 to illuminate the visible region on the reel 5 with various colors/patterns of light.

On the other hand, the game control unit 100 randomly determines which position or rotation angle each reel 5 is to be stopped at, i.e., which symbols are to be displayed at the visible region on each stopped reel 5. In addition, the game control unit 100 randomly determines which illumination colors/patterns the lighting units 57 in each reel assembly 50 should use to illuminate the visible region on the stopped reel 5. Furthermore, the game control unit 100 checks whether a winning combination of symbols will appear in the selected payline on the stopped reel 5. If so, the game control unit 100 determines a type of award, e.g., a payout or a right of playing a bonus game, to be provided to the player, depending on the type of the winning combination appearing in the selected payline and the amount of the bet placed thereon.

After a predetermined time has elapsed from the start of the spin, the game control unit 100 causes the reel control unit 101 to stop the reels 5 at the predetermined positions. If having detected a winning combination that represents an amount of a payout, the game control unit 100 will increase the available credits by the payout, or causes the coin hopper 105 to discharge the coins equivalent to the payouts. If having detected a winning combination that represents a right of playing a bonus game, the game control unit 100 will start a bonus round. In addition, the game control unit 100 controls the lighting devices 2, 6A, 6B, 6C, the display devices 3A, 3B, 3C, and the speaker 107 to produce visual and sound effects to announce the winning of the payout or the start of the bonus round.

In determining whether or not a win has occurred, the game control unit 100 deals with a single symbol as a different type depending on an illumination color or pattern. Here, the game control unit 100 predetermines and stores a relationship between illumination colors/patterns and symbol types. In order to ensure exact consistency between actual colors/patterns of illuminated symbols and symbol types to be visible in the display windows 4, the color check unit 54 is used to quickly detect inconsistency therebetween as follows.

The color check unit 54 monitors a level of a driving current flowing in each lighting unit 57. The color check unit 54 further generates an error signal ERR when detecting that a level of a driving current indicates inconsistency between the actual color/pattern of the illuminated symbol and the symbol types to be visible.

The error signal ERR includes identification data of the lighting unit 57 in an error state. In response to the error signal ERR, the lighting control unit 102 immediately informs the game control unit 100 of an error of a lighting unit 57 and the identification data of the erroneous lighting unit 57, preferably by using an interrupt request INT. In response to the interrupt request INT, the game control unit 100 will immediately suspend a game in progress, and then take appropriate steps to inform a player and/or an attendant of the error. For example, the game control unit 100 will first save data about current game conditions such as a game status, a current number of available credits, etc., and log an event of the error. The game control unit 100 will next disable a game play, e.g., cause the reel control unit 101 to continuously revolve all the reels 5 in order not to stop at any position. The game control unit 100 will further control the lighting devices 2, 6A, 6B, 6C, the display devices 3A, 3B, 3C, and the speaker 107 to produce a specific signal or message to announce the error. The game control unit 100 will in particular announce the identification data of the erroneous lighting unit 57 by a display on any display device 3A, 3B, 3C, or by sounds from the speaker 107. This announcement allows an attendant to quickly identify the erroneous lighting unit 57 and replace it with a new one. After the replacement, the gaming machine 11 loads the saved game conditions, immediately resuming a game from where it was suspended.

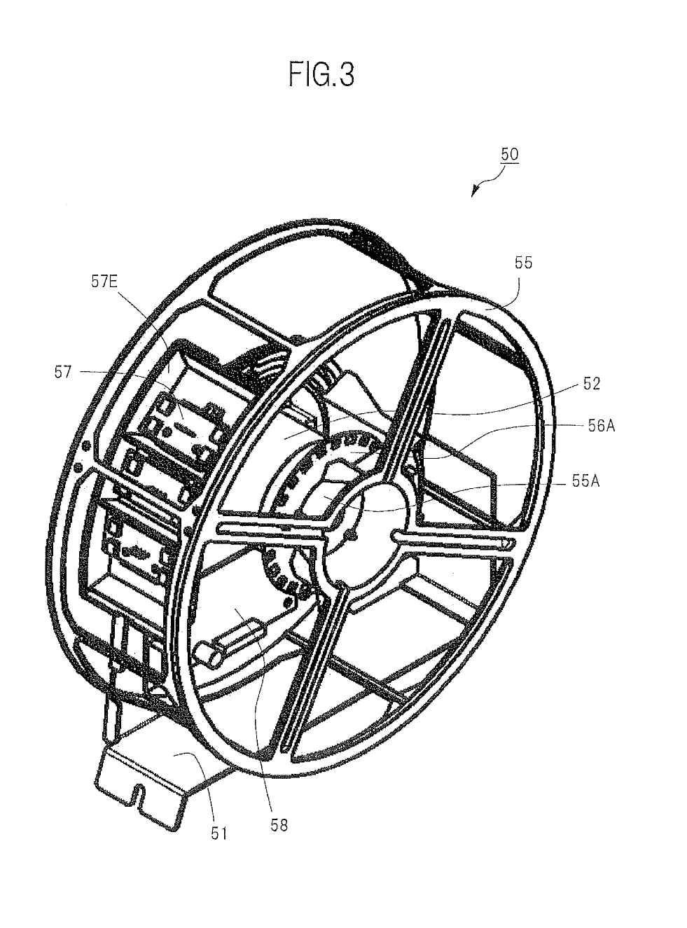

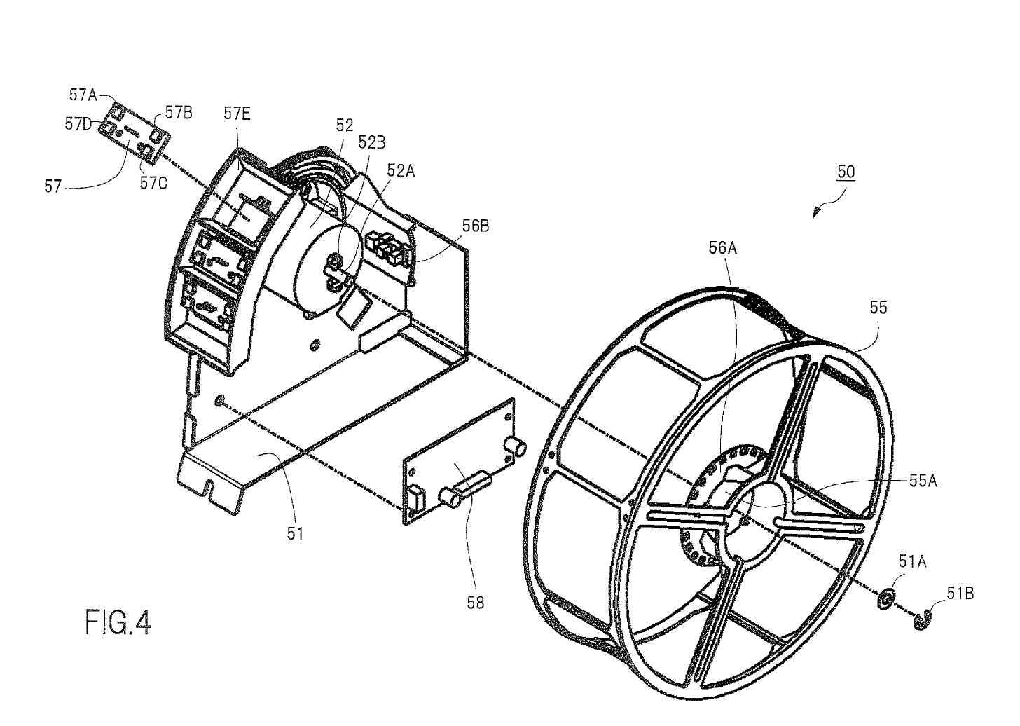

Referring to FIGS. 3 and 4, each reel assembly 50 includes a supporting member 51, a motor 52, a mechanical reel 55, a rotary encoder 56A, 56B, three lighting units 57, and a circuit board 58.

The supporting member 51 is preferably formed by metal, fixed inside the cabinet 1 behind each display window 4 shown in FIG. 1. The motor 52 is mounted on the supporting member 51. The shaft 52A of the motor 52 has two branches perpendicular to the shaft 52A fixed at the base thereof, and a female thread formed at the tip thereof. An elastic member 52B, preferably an O-ring made of an elastomer, is positioned around each branch of the shaft 52A.

The reel 55 is preferably a plastic drum, the whole of which is integrally molded, or parts of which are separately molded and combined into one. The symbols such as 5SA, 5SB, 5SC shown in FIG. 1 are preferably printed on a strip of transparent paper, or alternatively may be displayed on a flexible display device such as a flexible liquid crystal display device (LCD), an organic electroluminescent display device (OLED), one or more sheets of electric paper. The strip of paper or the flexible display device is wound around the reel 55 to constitute the circumferential surface thereof.

The shaft 52A of the motor 52 is inserted in a hole opened at the center portion 55A of the reel 55 along the center axis thereof. A hollow is formed at the surface of the center portion 55A opposed to the front surface of the motor 52 (not shown in FIGS. 3 and 4). The elastic members 52B fit in the hollow, and can deform in the axial and circumferential directions of the shaft 52A. The shaft 52A passes through the hole of the center portion 55A, and a washer 51A in that order. A screw 51B is coupled to the female thread at the tip of the shaft 52A. The screw 51B then presses the center portion 55A of the reel 55 in the axial direction, and thereby secures the reel 55 on the shaft 52A. The motor 52 rotates the reel 55 around its center axis under control of the reel control unit 101 (cf. FIG. 2). In particular, the motor 52 exerts torque on the reel 55 through circumferential compression of the elastic members 52B. In this case, the circumferential deformation of the elastic members 52B absorbs circumferential vibrations of the reel 55 quickly and reliably at a stop position.

The rotary encoder includes a disk 56A, an LED, and a photodetector 56B. The disk 56A is coaxially fixed at the surface of the center portion 55A of the reel 55. A number of slots are uniformly spaced along the rim of the disk 56A. The LED and the photodetector 56B are mounted on the inner surface of the supporting member 51, and opposed to each other. The LED emits a ray of light, and the photodetector detects the ray. Between the pair, the rim of the disk 56A is placed. While each slots of the disk 56A passes between the pair, the photodetector can detect the ray emitted from the LED. Otherwise, the rim of the disk 56A cuts off the ray and prevents the photodetector 56B from detecting the ray. The reel control unit 101 measures the number and frequency of output pulses sent from the photodetector 56B, and thereby monitors a current position or rotation angle and a rotation speed of the reel 55.

Each lighting unit 57 preferably includes a small circuit board and four LED units 57A, 57B, 57C, 57D each mounted on a corner of the circuit board. Each LED unit 57A, 57B, 57C, 57D preferably includes at least one of red, green, and blue LEDs, and more preferably includes all of these colored LEDs. Note that the number of each colored LED is preferably one per LED unit, but may be freely adjusted. All the four LED units 57A, 57B, 57C, 57D in each lighting unit 57 emit rays of light in the normal direction to the surface of the circuit board. Among the four LED units 57A, 57B, 57C, 57D in each lighting unit 57, the same colored LEDs are connected in series. In other words, each lighting unit 57 includes a series of four red LEDs, a series of four green LEDs, and a series of four blue LEDs. A series of the same colored LEDs is driven by a common driving current. Accordingly, all the four LED units 57A, 57B, 57C, 57D emit the same colored rays of light.

A housing 57E having a round shape along the circumference of the reel 55 is mounted on the supporting member 51 in a position of facing the display window 4 shown in FIG. 1. The three lighting units 57 are separately placed inside the housing 57E along the circumference of the reel 55. The lighting units 57 are configured to emit colored rays of light from the inside of the reel 55 to the display window 4, thereby illuminating three separate regions arranged along the circumference of the reel 55 and visible in the display window 4. While the reel 55 is stopped, a single symbol is positioned in each illuminated region. Accordingly, three symbols per reel are illuminated by the respective lighting units 57.

Note that the number of lighting units per reel and the number of LED units per lighting unit may be freely adjusted. In particular, a matrix of LEDs may be mounted on each lighting unit. In the case where symbols are displayed on a flexible LCD mounted on the reel 55, the lighting units 57 may be replaced with a backlight unit of the flexible LCD. In the case where symbols are displayed on an OLED mounted on the reel 55, the OLED may serve as lighting units.

The circuit board 58 is preferably mounted on the inner surface of the supporting member 51. The lighting driver unit 53 and the color check unit 54 shown in FIG. 2 are implemented on the circuit board 58.

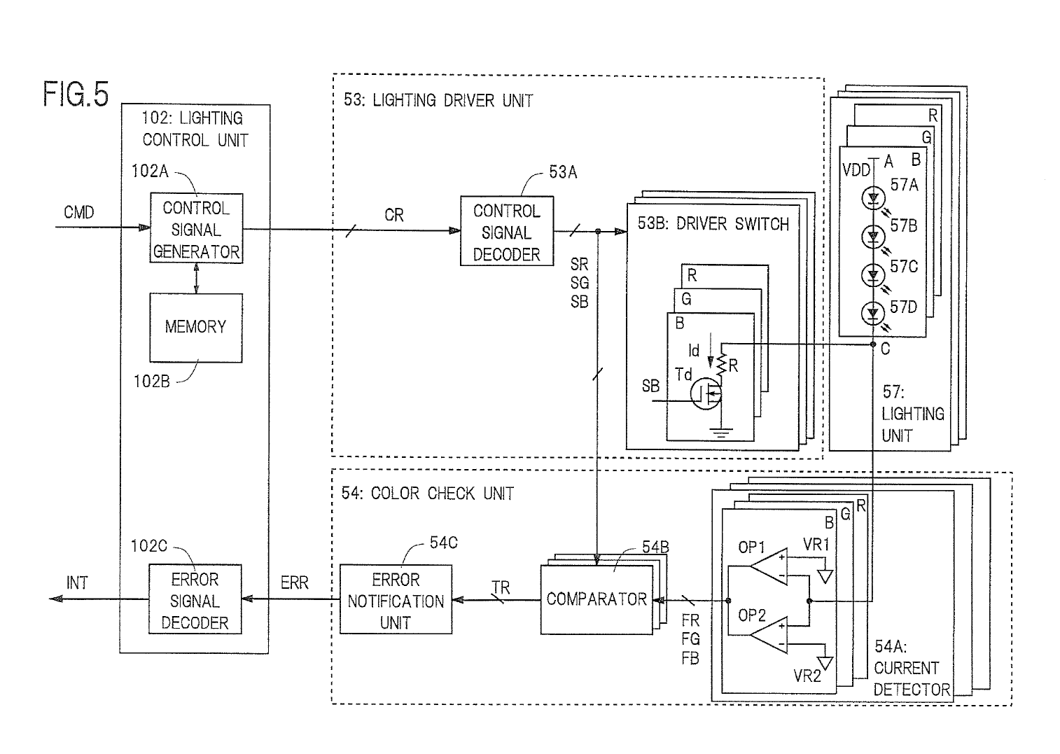

Referring to FIG. 5, the lighting control unit 102 and the lighting driver unit 53 preferably control intensity of colored rays emitted from a series of four LEDs 57A-57D by pulse width modulation of driving currents Id flowing therein. Here, each lighting unit 57 has a series of red LEDs, a series of green LEDs, and a series of blue LEDs among the four LED units 57A-57D. In this case, the color check unit 54 preferably monitors pulse levels of the driving currents Id, and thereby detects an excessive deviation in activation timing of any driving current Id. Details will be described as follows.

Referring to FIG. 5, the lighting control unit 102 preferably includes a control signal encoder unit 102A, a memory unit 102B, and an error signal decoder 102C.

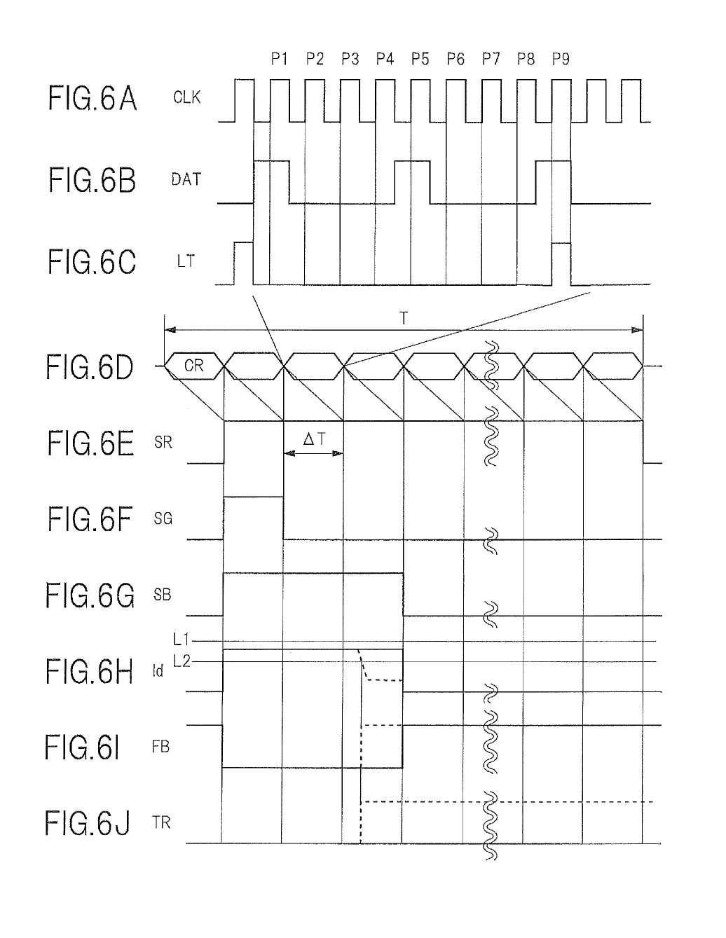

The control signal encoder unit 102A receives a command CMD from the game control unit 100. Here, the command CMD represents target brightness levels of LEDs included in the LED units 57A-57D of the lighting units 57. The target brightness levels are preferably expressed with a predetermined number of gradation steps, e.g. 32. The control signal encoder unit 102A decodes the command CMD into the target brightness levels of LEDs, and then generates a group of LED control signals CR according to the target brightness levels. Referring to FIG. 6D, the LED control signals CR represent ON/OFF states of all the LEDs at regular unit intervals ΔT, e.g. 0.5 msec. The control signal encoder unit 102A periodically repeats the transmission of the LED control signals CR at transmission intervals T, until receiving the next command CMD from the game control unit 100. Each transmission interval T is equal to the number of the gradation steps times the unit interval ΔT, e.g., T=32×0.5 msec=15.5 msec.

The LED control signals CR preferably includes a clock signal CLK, a data signal DAT, and a latch signal LT.

Referring to FIG. 6A, the clock signal CLK preferably includes the same number of pulses P1, P2, . . . , P9 in each unit interval ΔT as the total number of series of LEDs including in all the three lighting units 57, e.g., 9=3×3. Each pulse P1, P2, . . . , P9 of the clock signal CK included in the unit interval ΔT is assigned to a different series of LEDs. In FIGS. 1 and 6A, for example, the first pulse P1, the second pulse P2, and the third pulse P3 are assigned to a series of red, green, and blue LEDs of the top lighting unit 57, respectively. The fourth pulse P4, the fifth pulse P5, and the sixth pulse P6 are assigned to a series of red, green, and blue LEDs of the middle lighting unit 57, respectively. The seventh pulse P7, the eighth pulse P8, and the ninth pulse P9 are assigned to a series of red, green, and blue LEDs of the bottom lighting unit 57, respectively.

Referring to FIG. 6B, the data signal DAT has either high or low level at the rising edge of each pulse P1, . . . , P9 of the clock signal CLK. The high or low level represents an ON or OFF state of LEDs in series assigned to each pulse P1, . . . , P9, respectively. Conversely, the high or low level may represent an OFF or ON state of LEDs in series, respectively. In FIGS. 6A and 6B, for example, the data signal DAT has a high level at the rising edges of the first pulse P1, the fifth pulse P5, and the ninth pulse P9 of the clock signal CLK. This represents ON states of red LEDs of the top lighting unit 57, green LEDs of the middle lighting unit 57, and blue LEDs of the bottom lighting unit 57 during the next unit interval ΔT. On the other hand, the data signal DAT has a low level at the rising edges of the other pulses P2-P4, P6-P8 of the clock signal CLK. This represents OFF states of the other LEDs during the next unit interval ΔT.

Referring to FIG. 6C, the latch signal LT has a pulse whose falling edge represents a boundary between two adjacent unit intervals ΔT.

The memory unit 102B stores links between target brightness levels represented by the command CMD and patterns of the data signal DAT during a transmission interval T of the LED control signal CR. The control signal encoder unit 102A accesses the memory unit 102B to retrieve a pattern of the data signal DAT linked to target brightness levels that the received command CMD represents.

The error signal decoder 102C receives an error signal ERR from the color check unit 54, and then decodes the error signal ERR into data on a series of LEDs in an error state, esp., identification data of the erroneous series of LEDs or the lighting unit 57 that includes the erroneous series of LEDs. The error signal decoder 102C further generates an interrupt request INT to inform the game control unit 100 of the data on the erroneous series of LEDs.

Referring to FIG. 5, the lighting driver unit 53 includes a control signal decoder unit 53A and a driver switch unit 53B.

The control signal decoder unit 53A receives the LED control signals CR from the control signal encoder unit 102A, and then generates switching signals SR, SG, and SB based on the LED control signals CR. More specifically, the control signal decoder unit 53A first detects the states of the data signal DAT at the rising edges of the pulses P1, P2, . . . , P9 of the clock signal CLK during a unit interval ΔT between two adjacent pulses of the latch signal LT (cf. FIGS. 6A-6C). The control signal decoder unit 53A then asserts or negates each type of the switching signals SR, SG, SB, . . . during the next unit interval ΔT. Here, the switching signals preferably include the same number of types SR, SG, SB, . . . as the total number, e.g. 9, of the series of LEDs 57A-57D included in all the lighting units 57. Each type of the switching signals SR, SG, SB, . . . is assigned to a different pulse P1, P2, . . . , P9 of the clock signal CLK in each unit interval ΔT, and accordingly is to a different series of LEDs 57A-57D. In FIGS. 6E, 6F, and 6G, for example, three types of the switching signals, i.e., a red switching signal SR, a green switching signal SG, and a blue switching signal SB are assigned to the series of red, green, and blue LEDs 57A-57D in a single lighting unit 57, respectively. Depending on whether the data signal DAT is asserted or negated at the rising edge of each pulse P1, P2, . . . , P9 of the clock signal CLK during a unit interval ΔT, the control signal decoder unit 53A asserts or negates the corresponding switching signals SR, SG, SB during the next unit interval ΔT. In FIGS. 6E, 6F, and 6G, for example, the red switching signal SR is asserted throughout the transmission interval T, the green switching signal SG is asserted only during the first unit interval ΔT included in the transmission interval T, and the blue switching signal SB is asserted during the first through third unit intervals ΔT included in the transmission interval T.

Referring to FIG. 5, the driver switch unit 53B includes switching devices Td as many as the total number, e.g. 9, of the series of LEDs 57A-57D included in all the lighting units 57. Each switching device Td is connected between a ground terminal and the cathode C of a different series of LEDs 57A-57D. Here, the anode A of each series of LEDs 57A-57D is maintained at a high voltage VDD. The switching device Td conducts and cuts off the driving current Id flowing in the series of LEDs 57A-57D. The switching devices Td are preferably FETs, or alternatively may be bipolar transistors or photocouplers. The control terminal of each switching device Td (e.g. the gate of a FET) receives a different type of the switching signals SR, SG, SB, and thus the switching device Td is turned ON and OFF when the type of switching signal is asserted and negated, respectively. Referring to FIG. 6H, during an ON and OFF time of the switching device Td, the driving current Id flows and stops flowing in the series of LEDs 57A-57D connected to the switching device Td, respectively, then turning ON and OFF the LEDs 57A-57D, respectively. In FIGS. 6E, 6F, and 6G, for example, the first switching device Td received the red switching signal SR is turned ON throughout the transmission interval T, the second switching device received the green switching signal SG is turned ON only during the first unit interval ΔT in the transmission interval T, and the third switching device Td received the blue switching signal SB is turned ON during the first through third unit intervals ΔT in the transmission interval T. Accordingly, in the lighting unit 57, red LEDs emit light throughout the transmission interval T, green LEDs emit light only during the first unit interval ΔT, and blue LEDs emits light during the first through third unit intervals ΔT. Thus, a duty ratio, i.e., a brightness level of each series of LEDs in the transmission interval T is adjusted at one of gradation steps, e.g. 32 steps, as many as the total number of unit intervals ΔT per transmission interval T. The combination of duty ratios between red, green, and blue LEDs determines an actual color of light emitted by each lighting unit 57, i.e., the color of a symbol illuminated by the lighting unit 57.

Referring to FIG. 5, the color check unit 54 includes a current detector unit 54A, a comparator unit 54B, and an error notification unit 54C.

The current detector unit 54A includes a pair of a first comparator device OP1 and a second comparator device OP2, and a pair of a first reference voltage source VR1 and a second reference voltage sourceVR2, which are connected to each series of LEDs 57A-57D. Accordingly, the total number of pairs of comparator devices OP1, OP2 and the total number of pairs of reference voltage sources VR1, VR2 are both equal to the total number, e.g. 9, of series of LEDs 57A-57D including in all the lighting units 57. Each comparator device OP1, OP2 is preferably an operational amplifier. The positive input terminal of each first comparator device OP1 is connected to a first reference voltage source VR1. The negative input terminal of the first comparator device OP1 and the positive input terminal of a second comparator device OP2, which is paired with the first comparator device OP1, are connected to the cathode C of a series of LEDs 57A-57D. The negative input terminals of the second comparator device OP2 is connected to a second reference voltage source VR2, which is paired with the first reference voltage source VR1. In this case, a specific resistor R is preferably connected between the cathode C and the switching device Td.

While a driving current Id flows in the resistor R, a voltage VC at the cathode C is substantially maintained at a level equal to the amount of the driving current Id times the resistance of the resistor R. The first comparator device OP1 compares the voltage VC at the cathode C with the first reference voltage VR1. If the voltage VC exceeds the first reference voltage VR1, or equivalently, the amount of the driving current Id exceeds an upper limit L1 shown in FIG. 6H, the first comparator device OP1 asserts its output signal. If the voltage VC falls below the second reference voltage VR2, or equivalently, the driving current Id is reduced below a lower limit L2 shown in FIG. 6H, the second comparator device OP2 asserts its output signal. The output signals of the two comparator devices OP1, OP2 form a type of feedback signal FR, FG, FB, preferably through a wired-OR connection. Referring to FIG. 6I, the feedback signal FR, FG, FB is asserted when the output signal of either comparator device OP1, OP2 is asserted.

In that manner, the current detector unit 54A generates the same number of types of feedback signals FR, FG, FB as the total number, e.g. 9, of series of LEDs 57A-57D including in all the lighting units 57. The current detector unit 54A in particular asserts or negates each type of the feedback signals FR, FG, FB, depending on whether or not the level of a corresponding driving current Id falls outside a predetermined range between an upper limit L1 and a lower limit L2. In particular, each feedback signal FR, FG, FB is asserted and negated while a corresponding driving current Id is normally cut off and conducted, respectively. Accordingly, the feedback signal FR, FG, FB falls and rises at the rising and falling edge of the driving current Id, respectively, as shown in FIGS. 6H, 6I.

Note that each reference voltage VR1, VR2 may have a different level for a different series of LEDs. Accordingly, acceptable ranges of driving currents Id may vary with series of LEDs.

The comparator unit 54B is preferably implemented in a programmable logic device. The comparator unit 54B receives switching signals SR, SG, SB from the control signal decoder 53A, and feedback signals FR, FG, FB from the current detector unit 54A. The comparator unit 54B then pairs each switching signal SR, SG, SB with a feedback signal FR, FG, FB that follows a driving current Id conducted and cut off by a switching device Td according to the switching signal SR, SG, SB. The comparator unit 54B monitors states of each pair (SR, FR), (SG, FG), (SB, FB) of switching and feedback signals.

Under normal conditions, rising and falling a switching signal SB causes a switching device Td reliably to turn on and off a driving current Id. Accordingly, the driving current Id flowing in the switching device Td rises and falls in accurate synchronization with the rising and falling of the switching signal SB, as the solid lines shown in FIG. 6H. Accordingly, the feedback signal FB caused by the driving current Id falls and rises in accurate synchronization with the rising and falling of the switching signal SB, as the solid lines shown in FIG. 6I. Therefore, the pair of the switching signal SB and the feedback signal FB maintains opposite states, i.e., one of the pair is asserted and the other is negated.

If a driving current Id accidentally rises or falls in a manner inconsistent with a control signal CR, the series of LEDs in which the driving current Id flows will emit a colored ray having an intensity different from a desired one indicated by the control signal CR. This can improperly change the color of the symbol illuminated by the series of LEDs. For example, though a blue switching signal SB is asserted to turn on a switching device Td during the first through third unit intervals ΔT of a transmission interval T as shown in FIG. 6G, the driving current Id flowing in the switching device Td is accidentally reduced below the lower limit L2 in the third unit interval ΔT, as shown by broken lines in FIG. 6H. In that case, a series of blue LEDs in which the driving current Id flows will stop emitting a blue ray before the end of the third unit interval ΔT. Accordingly, an actual brightness level of the series of blue LEDs will not reach a desired one indicated by the control signal CR.

On the other hand, accidental rising and falling of a driving current Id simultaneously causes a feedback signal to fall and rise, respectively. For example, as shown by broken lines in FIGS. 6H and 6I, accidental falling of the driving current Id below the lower limit L2 causes a feedback signal FB to be asserted at the same time in the third unit interval ΔT. As a result, the pair of the blue switching signal SB and the feedback signal FB maintains the same state, i.e., both of the signals SB, FB are asserted after the accidental falling of the driving current Id. When detecting that the pair of switching and feedback signals SB, FB maintains the same state, the comparator unit 54B then asserts a trigger signal TR as shown by broken lines in FIG. 6J. Preferably, the total number of types of trigger signals TR is equal to the total number of types of feedback signals FR, FG, FB, i.e., the total number of the series of LEDs 57A-57D. Thus, the comparator unit 54B can check whether or not level consistency is maintained between the control signal CR and each feedback signal FR, FG, FB, i.e., each output of the current detector unit 54A.

The error notification unit 54C simultaneously receives a group of trigger signals TR from the comparator unit 54B, and then determines, from an asserted trigger signal TR, which lighting unit 57 has a series of LEDs in an error state. The error notification unit 54C then encodes an error signal ERR with data on a series of LEDs in an error state, esp. identification data of the series of LEDs or the lighting unit 57 including the series of LEDs. Here, the error signal ERR is preferably a digital signal. The error notification unit 54C preferably transmits bits of the error signal ERR in turn over a single line. The error signal ERR is received and decoded by the error signal decoder 102C into the data on the series of LEDs in an error state.

In FIG. 5, the lighting control unit 102 and the lighting driver unit 53 use a pulse width modulation scheme to control a time period during which a constant level of a driving current Id flows in each series of LEDs 57A-57D, and the color check unit 54 detects an excessive deviation in activation timing of any driving current Id. Alternatively, the lighting control unit 102 and the lighting driver unit 53 may control a driving current Id flowing in each series of LEDs 57A-57D at a target level continuously changed with a target illumination color or pattern by the LEDs 57A-57D. In this case, the color check unit 54 may detect a level of any driving current Id excessively deviating from its target level.

As described above, in the gaming machine 11 according to the first embodiment of the invention, the game control unit 100 determines target illumination colors or patterns of the visible regions of the circumferential surfaces of the reels 5, depending on which symbol types symbols 5SA, 5SB, 5SC illuminated with different colors or patterns are to be dealt with as. The game control unit 100 further causes the lighting control unit 102 and the lighting driver unit 53 to control driving currents Id flowing in series of LCDs 57A-57D of the lighting units 57, thereby achieving the target illumination colors or patterns of the symbols 5SA, 5SB, 5SC. On the other hand, the color check unit 54 monitors the levels of the driving currents Id, and generates an error signal ERR when detecting the level of any driving current Id falls outside a predetermined range L1-L2. In response to the error signal ERR, the lighting control unit 102 informs the game control unit 100 of an error in any lighting unit 57. This enables the game control unit 100 to immediately detect an illumination color or pattern in any symbol 5SA, 5SB, 5SC deviating from the target one. The game control unit 100 then takes appropriate steps to inform a player and/or an attendant of the error.

Thus, the gaming machine 11 can immediately detect inconsistency between a type and an actual illumination color/pattern of each symbol 5SA, 5SB, 5SC, thereby ensuring exact consistency therebetween under normal conditions. Therefore, the gaming machine 11 can increase the variety of symbols by using various illumination colors/patterns with a sufficiently high level of reliability about consistency between illumination colors/patterns and symbol types.

In the first embodiment, the error signal ERR in particular includes identification data of a lighting unit 57 in an error state. In response to the error signal ERR, the lighting control unit 102 immediately informs the game control unit 100 of the identification data of the erroneous lighting unit 57, and then, the game control unit 100 immediately informs an attendant of the identification data. This allows the attendant to quickly replace the erroneous lighting unit 57 with a new one. Therefore, the gaming machine 11 can immediately resume a game.

### The Second Embodiment

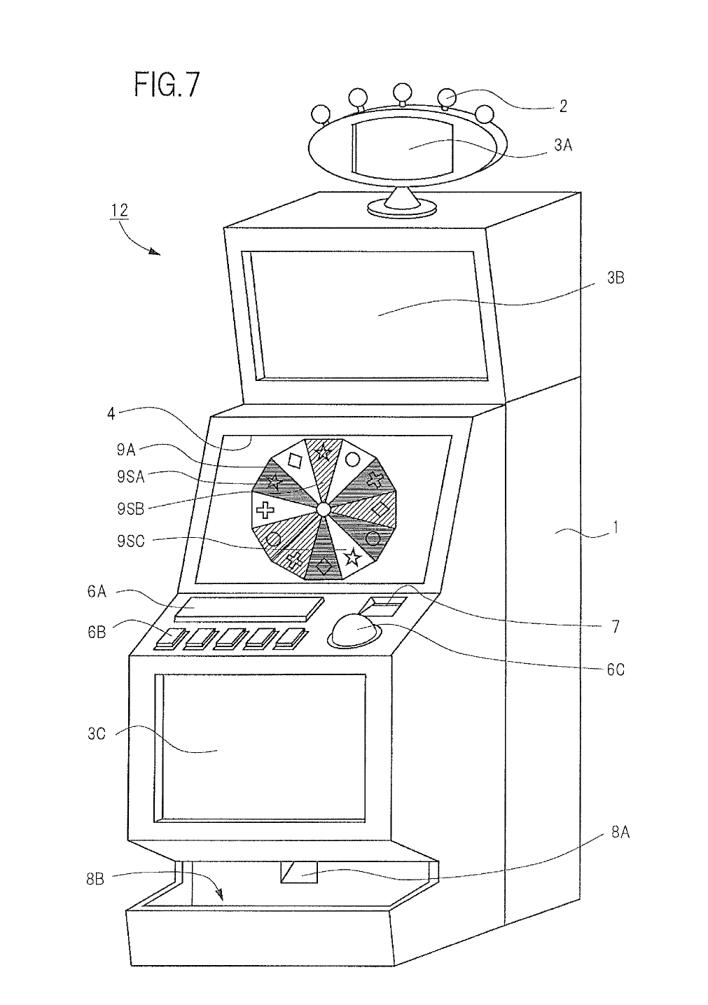

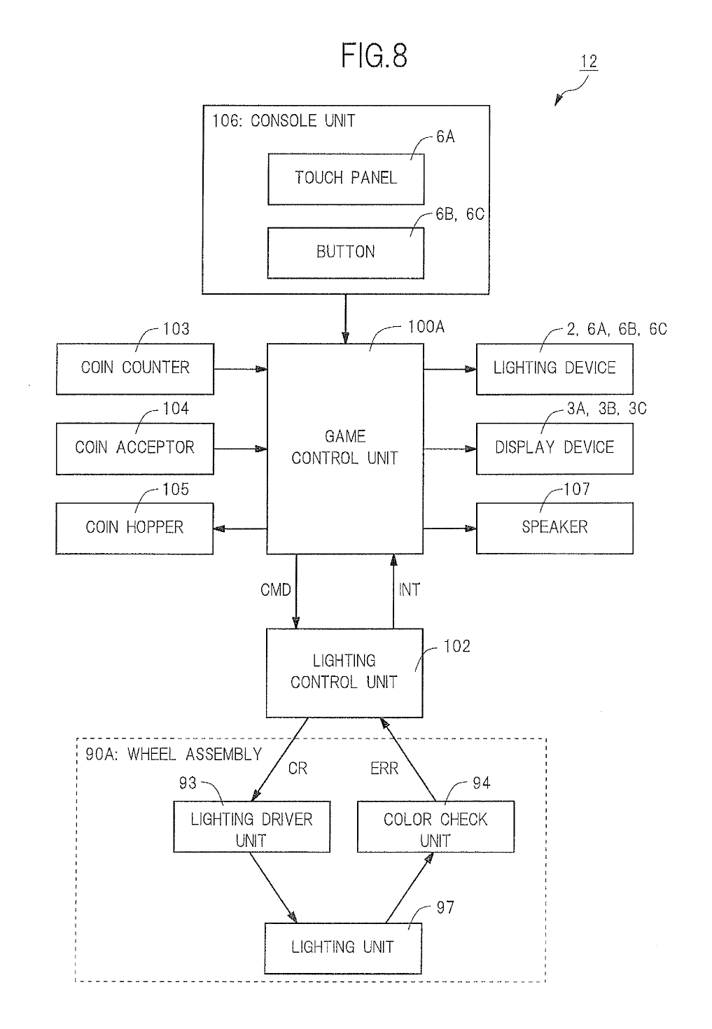

Referring to FIG. 7, a gaming machine 12 according to the second embodiment of the invention is preferably a wheel-of-chance machine. As components visible from the exterior, this gaming machine 12 includes a wheel of chance 9A, as well as a cabinet 1, lamps 2, display devices 3A, 3B, 3C, a touch panel 6A, operation buttons 6B, a spin button 6C, a coin/bill slot 7, a coin chute 8A, and a coin tray 8B. Referring to FIG. 8, this gaming machine 12 also includes a wheel assembly 90A as a component mounted inside the cabinet 1 and invisible from the exterior, as well as a game control unit 100A, a lighting control unit 102, a coin counter 103, a coin acceptor 104, a coin hopper 105, a console unit 106, and a speaker 107.

As compared to FIGS. 1 and 2, FIGS. 7 and 8 show similar components marked with the same reference numbers, except for the game control unit 100A and the wheel assembly 90A. A description of the similar components can be found above in the description of the first embodiment.

The display window 4 is comprised of a large hole provided in front of the cabinet 1 as shown in FIG. 7. The hole is preferably covered with glass. Behind the display windows 4, the wheel of chance 9A is fixed to face its front surface to be visible from a player's side of the cabinet 1. The front surface preferably has a regular dodecagon shape, i.e., a polygonal shape with twelve sides of the same length, or alternatively may have another polygonal shape or a circular shape. The front surface is divided into a plurality of regions, e.g. twelve regions having the same sectorial shape, on each of which a symbol 9SA, 9SB, 9SC is displayed. The symbol 9SA, 9SB, 9SC may be a geometric figure, a mark, a character, a letter, or a number.

The wheel of chance 9A is included in the wheel assembly 90A. Referring to FIG. 8, the wheel assembly 90A includes a lighting driver unit 93, a color check unit 94, and a plurality of lighting units 97, in addition to the wheel 9A.

Each lighting unit 97 illuminates a different sectorial region of the surface of the wheel 9A with colored rays of light. The lighting driver unit 93 allows a driving current to flow in each lighting unit 97 in accordance with control signals CR received from the lighting control unit 102, thereby changing illumination colors and/or patterns of the sectorial regions of the surface of the wheel 9A. The same symbols illuminated with different colors and/or patterns are dealt with as different symbol types. In FIG. 7, for example, the same “star” symbols 9SA, 9SB, 9SC with different colors are dealt with as different symbol types. Alternatively, different variation pattern in color, brightness, blinking frequency, or other attribute of light, may distinguish between the same “star” symbols 9SA, 9SB, 9SC as being different symbol types. Accordingly, the number of the symbol types visible on the wheel 9A is several times as many as the number of the symbols actually displayed on the wheel 9A, depending on the number of the colors and/or patterns that the lighting unit 97 can express.

The color check unit 94 checks consistency between actual colors/patterns of the illuminated symbols and symbol types to be visible on the wheel 9A. When detecting inconsistency therebetween, the color check unit 94 provides an error signal ERR to the lighting control unit 102. Detail will be described below.

Referring to FIG. 8, the game control unit 100A is preferably comprised of a microcomputer including a CPU, a ROM, and a RAM, as well as the lighting control unit 102. Alternatively, the two control units 100A, 102 may be separately composed of distinct pieces of hardware.

The game control unit 100A stores a game program. When receiving a cue for the start of a game from a player through the console unit 106, e.g., when the player enters coins/bills into the coin/bill slot 7, the game control unit 100A invokes the game program. After that, the game control unit 100A conducts the game according to the executed game program. In particular, the game control unit 100A controls other components installed on the gaming machine 12, depending on the game status as follows.

When a player enters coins/bills into the coin/bill slot 7, the game control unit 100A detects and accepts the coins/bills through the console unit 106, then increasing credits available to the player by the count provided by the coin counter 103. In parallel with that, the game control unit 100A starts to produce visual and sound effects by using the lighting devices 2, 6A, 6B, 6C, the display devices 3A, 3B, 3C, and the speaker 107.

When the player places a bet by using the touch panel 6A and/or the buttons 6B, the game control unit 100A identifies the bet accepted by the console unit 106, then decreasing the available credits by the amount of the bet. The game control unit 100A displays the amounts of the bet and the number of the available credits on the display devices 3A, 3B, and/or 3C.

When the console unit 106 detects that the player has pushed the spin button 6C, the game control unit 100A then provides the lighting control unit 102 with commands CMD to control the lighting driver unit 93 of the wheel assembly 90A to cause the lighting units 97 to change illumination brightness or colors in the sectorial regions of the surface of the wheel 9A in turn. This produces a visual effect of continuously revolving the brightest sectorial region or a sectorial region illuminated with a specific color/pattern in a clockwise or anti-clockwise direction.

On the other hand, the game control unit 100A randomly determines which sectorial region is to be finally selected as the brightest region or a region illuminated with a specific color/pattern of light. In addition, the game control unit 100A randomly determines which color/pattern the finally-selected sectorial region is to be illuminated with. Thus, the game control unit 100A randomly determines which type of symbol is to be finally selected. Depending on the type of the finally-selected symbol and the amount of the bet, the game control unit 100A further determines whether or not to provide an award to the player and which type of award, e.g. a payout or a right of playing a bonus game, to be provided to the player.

After a predetermined time has elapsed from the start of the visual effect of continuously revolving the brightest sectorial region or a sectorial region illuminated with a specific color/pattern, the game control unit 100A causes the lighting control unit 102 to stop the visual effect and illuminate the finally-selected sectorial region as the brightest one or with the specific color/pattern. If the type of a symbol displayed on the finally-selected sectorial region represents an amount of a payout, the game control unit 100A will increase the available credits by the payout, or causes the coin hopper 105 to discharge the coins equivalent to the payouts. If the type of a symbol displayed on the finally-selected sectorial region represents a right of playing a bonus game, the game control unit 100A will start a bonus round. In addition, the game control unit 100A controls the lighting devices 2, 6A, 6B, 6C, the display devices 3A, 3B, 3C, and the speaker 107 to produce visual and sound effects to announce the winning of the payout or the start of the bonus round.

Like the game control unit 100 of the first embodiment, the game control unit 100A also predetermines and stores a relationship between illumination colors/patterns and symbol types, thereby dealing with a single symbol as a different type depending on an illumination color or pattern. Accordingly, the color check unit 94 is used to quickly detect inconsistency between actual colors/patterns of illuminated symbols and symbol types to be visible on the wheel 9A as follows.

The color check unit 94 monitors a level of a driving current flowing in each lighting unit 97. The color check unit 94 further generates an error signal ERR when detecting that a level of a driving current indicates inconsistency between the actual color/pattern of the illuminated symbol and the symbol types to be visible. Note that the color check unit 94 may be not required to identify a lighting unit 97 in which the driving current whose level indicates the inconsistency, in contrast to the first embodiment.

In response to the error signal ERR, the lighting control unit 102 immediately informs the game control unit 100A of an error in any lighting unit 97, preferably by using an interrupt request INT. In response to the interrupt request INT, the game control unit 100A will immediately suspend a game in progress, and then take appropriate steps to inform a player and/or an attendant of the error. For example, the game control unit 100A will first save data about current game conditions such as a game status, a current number of available credits, etc., and log an event of the error. The game control unit 100A will next disable a game play, e.g., cause the lighting control unit 102 to continue the visual effect of revolving the brightest sectorial region or a sectorial region illuminated with a specific color/pattern in order not to select any sectorial region. The game control unit 100A will further control the lighting devices 2, 6A, 6B, 6C, the display devices 3A, 3B, 3C, and the speaker 107 to produce a specific signal or message to announce the error. This announcement allows an attendant to quickly replace the entirety of the erroneous wheel assembly 90A with a new one, not only the erroneous lighting unit 97 in contrast to the first embodiment. After the replacement, the gaming machine 12 loads the saved game conditions, immediately resuming a game from where it was suspended.

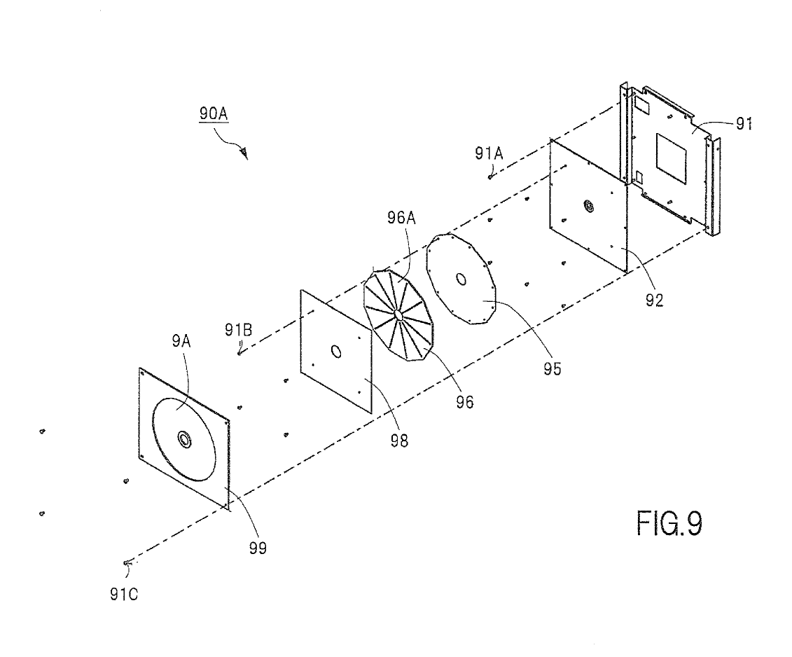

Referring to FIG. 9, each wheel assembly 90A includes a base member 91, a circuit board 92, a reflection sheet 95, a light guide panel 96, a diffusion sheet 98, and a display sheet 99.

The base member 91 is a preferably metal board, fixed inside the cabinet 1 behind the display window 4 shown in FIG. 7. The base member 91 has a front surface facing the display window 4.

The circuit board 92 is preferably a square printed circuit board, mounted and fixed by screws 91A on the front surface of the base member 91. The lighting driver unit 93 and the color check unit 54 shown in FIG. 8 are implemented on the back surface of the circuit board 92, and a plurality of the lighting units 97 are on the front surface thereof.

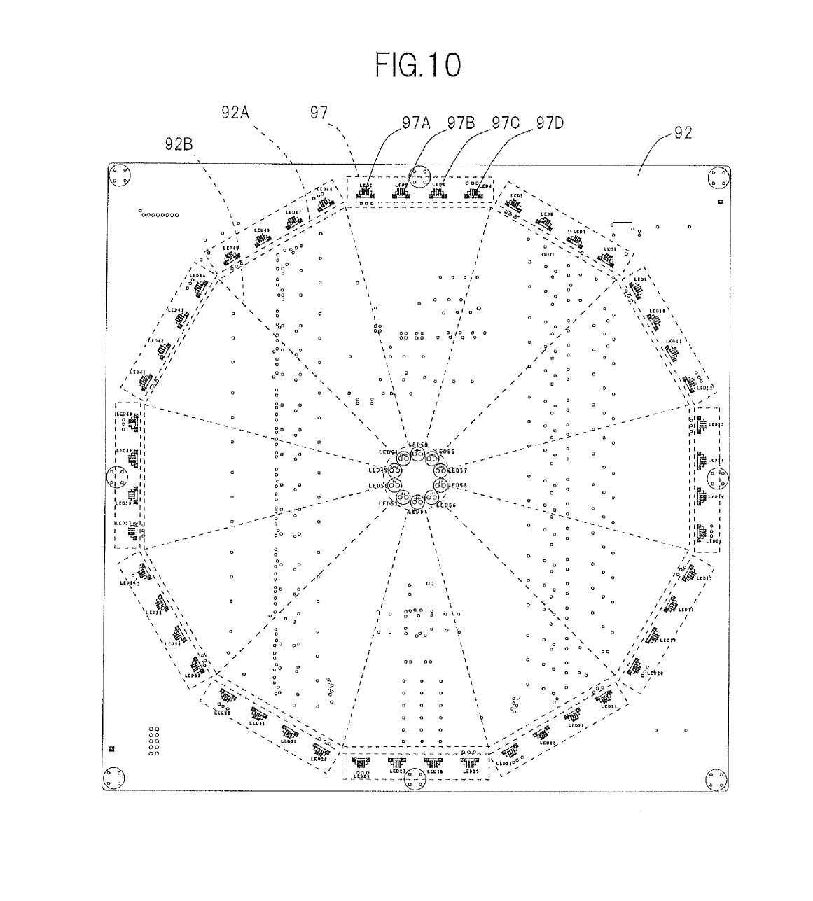

Referring to FIG. 10, twelve lighting units 97 are each placed along a different side of a regular dodecagon 92A, which is shown by broken lines. Each lighting unit 97 preferably includes four LED units 97A, 97B, 97C, and 97D equally spaced along a single side of the regular dodecagon 92A. Each LED unit 97A, 97B, 97C, 97D preferably includes at least one of red, green, and blue LEDs, and more preferably includes all of these colored LEDs. Note that the number of each colored LED is preferably one per LED unit, but may be freely adjusted. All the four LED units 97A, 97B, 97C, 97D in each lighting unit 97 emit rays of light in a direction to the center of the regular dodecagon 92A. Among the four LED units 97A, 97B, 97C, 97D in each lighting unit 97, the same colored LEDs are connected in series. In other words, each lighting unit 97 includes a series of four red LEDs, a series of four green LEDs, and a series of four blue LEDs. A series of the same colored LEDs is driven by a common driving current. A series of the same colored LEDs is driven by a common driving current. Accordingly, all the four LED units 97A, 97B, 97C, 97D emit the same colored rays of light.

The reflection sheet 95 has preferably the same shape as the regular dodecagon 92A shown by broken lines in FIG. 10. The reflection sheet 95 is placed over the regular dodecagon 92A and surrounded by the lighting units 97. The reflection sheet 95 has a front surface capable of reflecting incoming light forward.

The light guide panel 96 has preferably the same shape as the regular dodecagon 92A. The light guide panel 96 is placed over the reflection sheet 95 and surrounded by the lighting units 97. The light guide panel 96 is divided into twelve regions 96A having the same sectorial shape. Each sectorial region 96A is placed over a different sectorial region 92B of the regular dodecagon 92A, and then illuminated by the four LED units 97A-97D in a lighting unit 97 from a side of the regular dodecagon 92A. Light rays emitted from the LED units 97A-97D into the sectorial region 96A are diffusely reflected inside the sectorial region 96A, then emitted uniformly from the entirety of the front surface of the sectorial region 96A.

The diffusion sheet 98 has preferably a square shape, placed over the entirety of the light guide panel 96 and the lighting units 97. The laminated structure of the diffusion sheet 98, the light guide panel 96, and the reflection sheet 95 are fixed by the same screws 91B on the circuit board 92. The diffusion sheet 98 diffuses light emitted from the light guide panel 96 in forward directions, thereby enhancing brightness uniformity in each sectorial region 96A of the light guide panel 96 illuminated by the LED units 97A-97D.

The display sheet 99 has preferably a rectangular shape, placed over the entirety of the laminated structure of the diffusion sheet 98, the light guide panel 96, the reflection sheet 95, and the circuit board 92, and fixed by the screws 91C on the base member 91. The display sheet 99 has a transparent, circular region 9A with a diameter substantially equal to the length of a straight line that joins two opposite corners in the regular dodecagon 92A. In the circular region 9A, the ring of the symbols 9SA, 9SB, 9SC, . . . , shown in FIG. 7 are preferably printed. Alternatively, the circular region 9A may be equipped with a transparent display device such as an LCD panel or one or more sheets of electric paper, on which the ring of the symbols 9SA, 9SB, 9SC, . . . , may be displayed. Each symbols 9SA, 9SB, 9SC, is placed in a different sectorial region 96A of the light guide panel 96, thereby illuminated by a single lighting unit 97 with a different color/pattern. Thus, the circular region 9A is visible as the wheel of chance 9A shown in FIG. 7.

Note that the number of the lighting units 97 per wheel and the number of the LED units 97A-97D per lighting unit may be freely adjusted. Alternatively, a matrix of LEDs, radially arranged line light sources such as cold cathode fluorescent lamps (CCFL), or an OLED may be placed over the regular dodecagon 92A, instead of a surface light source of the light guide panel 96 surrounded by the LED units 97A-97D. In this case, each portion of the matrix of LEDs, the line light sources, or the OLED placed over a different sectorial region 92B of the regular dodecagon 92A may serve as a single lighting unit.

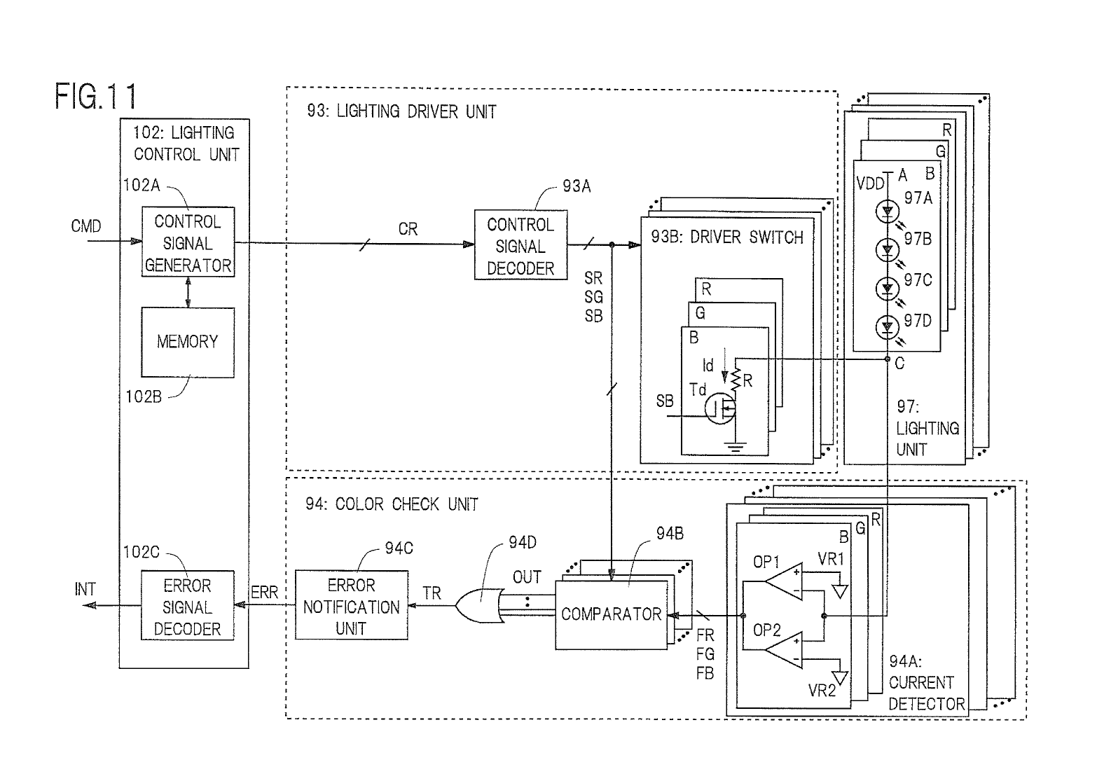

Referring to FIG. 11, the lighting control unit 102 and the lighting driver unit 93 preferably control intensity of colored rays emitted from a series of four LEDs 97A-97D by pulse width modulation of driving currents Id flowing therein. Here, each lighting unit 97 has a series of red LEDs, a series of green LEDs, and a series of blue LEDs among the four LED units 97A-97D. In this case, the color check unit 94 preferably monitors pulse levels of the driving currents Id, and thereby detects an excessive deviation in activation timing of any driving current Id. Details will be described as follows.

Like the lighting control unit 102 shown in FIG. 5, the lighting control unit 102 shown in FIG. 11 includes a control signal encoder unit 102A, a memory unit 102B, and an error signal decoder 102C. Accordingly, the following will describe these units 102A, 102B, 102C briefly. Detail descriptions of these units 102A, 102B, 102C can be found above in the description of the corresponding units of the first embodiment.

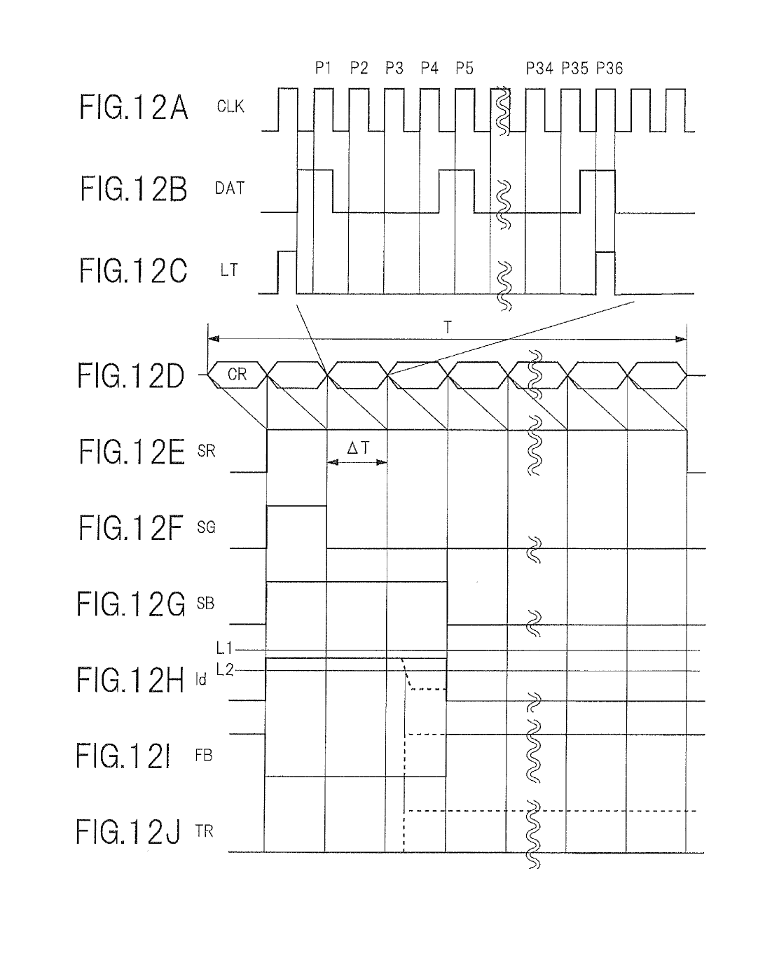

The control signal encoder unit 102A decodes a command CMD from the game control unit 100A into target brightness levels of LEDs of the lighting units 97. The control signal encoder unit 102A then generates a group of LED control signals CR, i.e., a clock signal CLK, a data signal DAT, and a latch signal LT, according to the target brightness levels, Referring to FIG. 12D, the control signal encoder unit 102A periodically transmits a fixed number of groups of the LED control signals CR at transmission intervals T, until receiving the next command CMD from the game control unit 100A. The fixed number is equal to the number of gradation steps, e.g. 32, with which the target brightness levels are expressed.

Referring to FIG. 12A, the clock signal CLK includes the same number of pulses P1, P2, . . . , P36 in each unit interval ΔT as the total number of series of LEDs including in all the twelve lighting units 97, e.g. 36=3×12. Each pulse P1, P2, . . . , P36 of the clock signal CK included in the unit interval ΔT is assigned to a different series of LEDs. In FIGS. 10 and 12A, for example, the first pulse P1, the second pulse P2, and the third pulse P3 are assigned to a series of red, green, and blue LEDs of a single lighting unit 57, respectively. In the case where a single unit interval ΔT=0.5 msec and a single transmission interval T=32×0.5 msec=15.5 msec, the frequency of the clock signal CLK is four times as high as that shown in FIG. 6A.

Referring to FIG. 12B, the data signal DAT has either high or low level at the rising edge of each pulse P1, . . . , P36 of the clock signal CLK. The high or low level represents an ON or OFF state of LEDs in series assigned to each pulse P1, . . . , P36, respectively, or vice versa. Referring to FIG. 12C, the latch signal LT has a pulse whose falling edge represents a boundary between two adjacent unit intervals ΔT.

The memory unit 102B stores links between target brightness levels and patterns of the data signal DAT during a transmission interval T.

The error signal decoder 102C receives an error signal ERR from the color check unit 94. The error signal decoder 102C then generates an interrupt request INT to inform the game control unit 100A of an error of a lighting unit 97. In contrast to the first embodiment, the error signal decoder 102C may be required to neither identify a series of LEDs in an error state, nor inform the game control unit 100A of identification data of the erroneous series of LEDs by an interrupt request INT.

Like the lighting driver unit 53 shown in FIG. 5, the lighting driver unit 93 shown in FIG. 11 includes a control signal decoder unit 93A and a driver switch unit 93B. These units 93A, 93B operates in a similar manner to the corresponding units 53A, 53B, respectively. Accordingly, the following will describe these units 93A, 93B briefly. Detail descriptions thereof can be found above in the description of the corresponding units 53A, 53B of the first embodiment, respectively.

The control signal decoder unit 93A first detects the states of the data signal DAT at the rising edges of each pulse P1, P2, . . . , P36 of the clock signal CLK during a unit interval ΔT (cf. FIGS. 12A-12C). Here, the same number of types of the switching signals SR, SG, SB, . . . as the total number, e.g. 36, of the series of LEDs 97A-97D are each assigned to a different pulse P1, P2, . . . , P36 included in the unit interval ΔT, and accordingly a different series of LEDs 97A-97D. Depending on whether the data signal DAT is asserted or negated at the rising edge of each pulse P1, P2, . . . , P36 of the clock signal CLK during the unit interval ΔT, the control signal decoder unit 93A asserts or negates a corresponding type of the switching signals SR, SG, SB during the next unit interval ΔT, as shown in FIGS. 12E-12G.

Referring to FIG. 11, the driver switch unit 93B includes the same number of switching devices Td as the total number, e.g. 36, of the series of LEDs 97A-97D included in all the lighting units 97. Each switching device Td conducts and cuts off a driving current Id flowing in a different series of LEDs 97A-97D, depending on whether a corresponding type of the switching signal SR, SG, SB is asserted or negated, as shown in FIGS. 12G, 12H. As a result, a duty ratio, i.e., a brightness level of each series of LEDs in the transmission interval T is adjusted at one of gradation steps, e.g. 32 steps, as many as the total number of unit intervals ΔT per transmission interval T, thus determining an actual color of light emitted by each lighting unit 97, i.e., the color of a sectorial region 96A or a symbol 91A, 91B, 91C illuminated by the lighting unit 97.

In contrast the color check unit 54 shown in FIG. 5, the color check unit 94 shown in FIG. 11 includes an OR gate unit 94D, as well as a current detector unit 94A, a comparator unit 94B, and an error notification unit 94C. Except for the OR gate unit 94D, the units 94A, 94B, 94C operate in similar manners to the corresponding units 54A, 54B, 54C shown in FIG. 5. Accordingly, the following will describe the units 94A, 94B, 94C briefly. Detail descriptions thereof can be found above in the description of the corresponding units 54A, 54B, 54C of the first embodiment.

The current detector unit 94A includes pairs of comparator devices OP1, OP2 and pairs of reference voltage sources VR1, VR2. Both the total number of the pairs is equal to the total number, e.g. 36, of the series of LEDs 97A-97D including in all the twelve lighting units 97. While a driving current Id flows in a specific resistor R connected between the cathode C of a series of LEDs 97A-97D and a switching device Td, a voltage VC at the cathode C is substantially maintained at a level equal to the amount of the driving current Id times the resistance of the resistor R. The paired comparator devices OP1, OP2 compare the voltage VC with the connected reference voltages VR1, VR2, respectively. If the voltage VC falls outside the range between the two reference voltages VR1, VR2, or equivalently, the amount of the driving current Id falls outside the range between an upper limit L1 and a lower limit L2 shown in FIG. 12H, either comparator device OP1, OP2 asserts its output signal, and accordingly does either feedback signal FR, FG, FB, through a wired-OR connection. Referring to FIG. 12I, the feedback signal FR, FG, FB is asserted and negated while the driving current Id is normally cut off and conducted, respectively. Accordingly, the feedback signal FR, FG, FB falls and rises at the rising and falling edge of the driving current Id, respectively, as shown in FIGS. 12H, 12I.

The comparator unit 94B pairs each switching signal SR, SG, SB from the control signal decoder 93A with a feedback signal FR, FG, FB that follows a driving current Id conducted and cut off by a switching device Td according to the switching signal SR, SG, SB. The comparator unit 94B monitors states of each pair (SR, FR), (SG, FG), (SB, FB) of switching and feedback signals. Under normal conditions, as shown by solid lines in FIGS. 12G and 12I, a pair of a switching signal SB and a feedback signal FB maintains opposite states, i.e., one of the pair is asserted and the other is negated. On the other hand, accidental falling of a driving current Id outside a range between the limits L1, L2, simultaneously causes a corresponding pair of a switching signal SB and a feedback signal FB maintain the same state, e.g., both paired signals SB, FB are asserted after an accidental falling of the driving current Id, as shown by broken lines in FIGS. 12H and 12I. When detecting that a pair of switching and feedback signals maintains the same state, the comparator unit 94B then asserts an output signal OUT. Preferably, the number of types of output signals OUT is equal to the number of types of feedback signals FR, FG, FB, i.e., the total number of the series of LEDs 97A-97D. Thus, the comparator unit 94B can check whether or not level consistency is maintained between the control signal CR and each feedback signal FR, FG, FB.

The OR gate unit 94D is preferably implemented in a programmable logic device. The OR gate unit 94D simultaneously receives a group of output signals OUT from the comparator unit 94B. If any output signal OUT is asserted, the OR gate unit 94D asserts its output signal or a trigger signal TR. When any pair of switching and feedback signals maintains the same state as shown by broken lines in FIGS. 12H and 12I, the OR gate unit 94D then asserts the trigger signal TR as shown by broken lines in FIG. 12J.

The error notification unit 94C receives a single trigger signal TR from the OR gate unit 94D, and then check if the trigger signal TR is asserted. If so, the error notification unit 94C then transmits an error signal ERR to the error signal decoder 102C of the lighting control unit 102. In contrast to the error notification unit 54C in the first embodiment, the error notification unit 94C may be required to identify neither a series of LEDs in an error state nor a lighting unit 97 including the series of LEDs. Accordingly, the error signal ERR is preferably a digital signal with a single bit. When receiving the error signal ERR, the error signal decoder 102C informs the game control unit 100A only of an error of any lighting unit 97 by an interrupt request INT.

As described above, in the gaming machine 12 according to the second embodiment of the invention, the game control unit 100A determines target illumination colors or patterns of each sectorial region of the surface of the wheel 9A, depending on which symbol types symbols 9SA, 9SB, 9SC illuminated with different colors or patterns in the sectorial regions are to be dealt with as. The game control unit 100A further causes the lighting control unit 102 and the lighting driver unit 93 to control driving currents Id flowing in series of LCDs 97A-97D of the lighting units 97, thereby achieving the target illumination colors or patterns of the symbols 9SA, 9SB, 9SC. On the other hand, the color check unit 94 monitors the levels of the driving currents Id, and generates an error signal ERR when detecting the level of any driving current Id falls outside a predetermined range L1-L2. In response to the error signal ERR, the lighting control unit 102 informs the game control unit 100A of an error in any lighting unit 97. This enables the game control unit 100A to immediately detect an illumination color or pattern in the symbol 9SA, 9SB, 5SC deviating from the target one. The game control unit 100A then takes appropriate steps to inform a player and/or an attendant of the error.

Thus, the gaming machine 12 can immediately detect inconsistency between a type and an actual illumination color/pattern of each symbol 9SA, 9SB, 9SC, thereby ensuring exact consistency therebetween under normal conditions. Therefore, the gaming machine 12 can increase the variety of symbols by using various illumination colors/patterns with a sufficiently high level of reliability about consistency between illumination colors/patterns and symbol types.

In the second embodiment, the error signal ERR may be not required to include identification data of a lighting unit 97 in an error state, since not only an erroneous lighting unit 97, but the entirety of the erroneous wheel assembly 90A may be replaced with a new one. This allows a trigger signal TR and/or an error signal ERR to be a one-bit signal, thereby simplifying the circuitry of the error notification unit 94C, regardless of a number of lighting units 97 installed in the wheel assembly 90A.

### The Third Embodiment

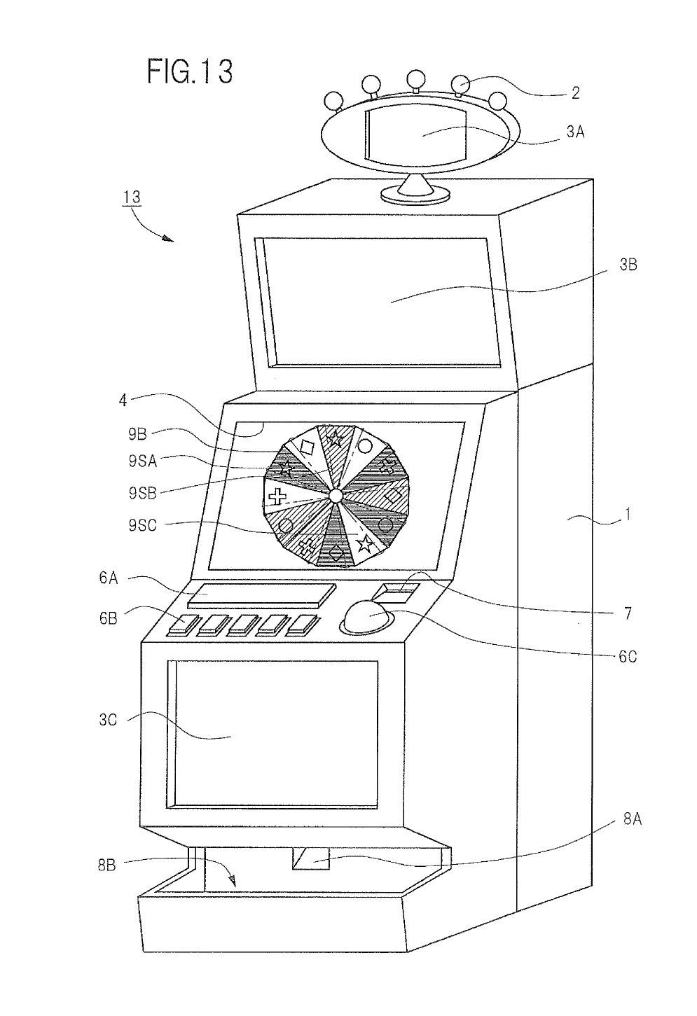

Referring to FIG. 13, a gaming machine 13 according to the third embodiment of the invention is preferably a wheel-of-chance machine. Like the gaming machine 12 of the second embodiment shown in FIG. 7, this gaming machine 13 shown in FIG. 13 includes a wheel of chance 9B, as well as a cabinet 1, lamps 2, display devices 3A, 3B, 3C, a touch panel 6A, operation buttons 6B, a spin button 6C, a coin/bill slot 7, a coin chute 8A, and a coin tray 8B, as components visible from the exterior.

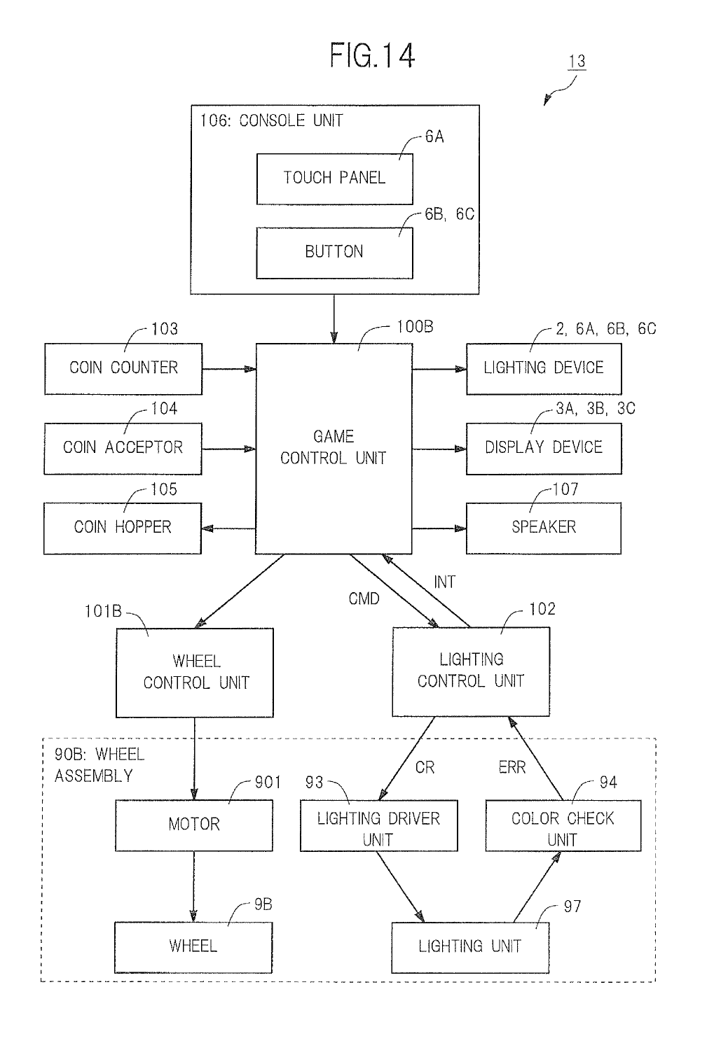

Referring to FIG. 14, the gaming machine 13 of the third embodiment also includes a wheel control unit 101B and a wheel assembly 90B as a component mounted inside the cabinet 1 and invisible from the exterior, as well as a game control unit 100B, a lighting control unit 102, a coin counter 103, a coin acceptor 104, a coin hopper 105, a console unit 106, and a speaker 107. The wheel assembly 90B includes a motor 901 as well as the wheel 9B, a lighting driver unit 93, a color check unit 94, and a lighting unit 97.

As compared to FIGS. 7 and 8, FIGS. 13 and 14 show similar components marked with the same reference numbers, except for the game control unit 100B, the wheel control unit 101B, and the wheel assembly 90B. A description of the similar components can be found above in the description of the first or second embodiment.

The wheel 9B of the third embodiment differs from the wheel 9A of the second embodiment in being rotatable around its center axis. The motor 901 is preferably a stepping motor having a shaft coupled to the center axis of the wheel 9B. The motor 901 controls the rotation angle and speed of the wheel 9B under control of the wheel control unit 101B. For example, the laminated structure of the display sheet 99, the diffusion sheet 98, the light guide panel 96, the reflection sheet 95, and the circuit board 92 shown in FIG. 9 may be rotatably mounted on the base member 91 with a center axis coupled to the shaft of the motor 901.

Referring to FIG. 14, the game control unit 100B, the wheel control unit 101B, and the lighting control unit 102 are preferably comprised of a microcomputer including a CPU, a ROM, and a RAM. Alternatively, the three control units 101B, 101B, and 102 may be separately composed of distinct pieces of hardware.

The wheel control unit 101B controls the motor 901 under control of the game control unit 100B, thereby rotating the wheel 9B at a desired speed and stopping it at a desired position.

The game control unit 100B stores a game program. When receiving a cue for the start of a game from a player through the console unit 106, e.g., when the player enters coins/bills into the coin/bill slot 7, the game control unit 100B invokes the game program. After that, the game control unit 100B conducts the game according to the executed game program. In particular, the game control unit 100B controls other components installed on the gaming machine 13, depending on the game status as follows.

When a player enters coins/bills into the coin/bill slot 7, the game control unit 100B detects and accepts the coins/bills through the console unit 106, then increasing credits available to the player by the count provided by the coin counter 103. In parallel with that, the game control unit 100B starts to produce visual and sound effects by using the lighting devices 2, 6A, 6B, 6C, the display devices 3A, 3B, 3C, and the speaker 107.

When the player places a bet by using the touch panel 6A and/or the buttons 6B, the game control unit 100B identifies the bet accepted by the console unit 106, then decreasing the available credits by the amount of the bet. The game control unit 100B further displays the amounts of the bet and the number of available credits on the display devices 3A, 3B, and/or 3C.

When the console unit 106 detects that the player has pushed the spin button 6C, the game control unit 100B then causes the wheel control unit 101B to command the motor 901 to rotate the wheel 9B. In synchronization with the spin, the game control unit 100B provides the lighting control unit 102 with commands CMD to control the lighting driver unit 93 of the wheel assembly 90B to cause the lighting units 97 to illuminate the respective sectorial regions on the wheel 9B with various colors/patterns of light.

On the other hand, the game control unit 100B randomly determines which sectorial region is to be stopped at a specific position such as the top position within the display window 4, i.e., which symbols are to be displayed there. In addition, the game control unit 100B randomly determines which color/pattern the sectorial region to be stopped at the specific position is to be illuminated with. Thus, the game control unit 100B randomly determines which types of symbol are to be stopped at the specific position. Depending on the type of symbol and the amount of the bet, the game control unit 100B further determines whether or not to provide an award to the player and which type of award, e.g. a payout or a right of playing a bonus game, to be provided to the player.

After a predetermined time has elapsed from the start of the spin, the game control unit 100B causes the wheel control unit 101B to stop the wheel 9B at the predetermined position. If the type of a symbol stopped at the specific position represents an amount of a payout, the game control unit 100B will increase the available credits by the payout, or causes the coin hopper 105 to discharge the coins equivalent to the payouts. If the type of a symbol stopped at the specific position represents a right of playing a bonus game, the game control unit 100B will start a bonus round. In addition, the game control unit 100B controls the lighting devices 2, 6A, 6B, 6C, the display devices 3A, 3B, 3C, and the speaker 107 to produce visual and sound effects to announce the winning of the payout or the start of the bonus round.

Like the game control unit 100A of the second embodiment, the game control unit 100B also predetermines and stores a relationship between illumination colors/patterns and symbol types, thereby dealing with a single symbol as a different type depending on an illumination color or pattern. Accordingly, the color check unit 94 is used to quickly detect inconsistency between actual colors/patterns of illuminated symbols and symbol types to be visible on the wheel 9B. A description of functions of the color check unit 94 can be found above in the description of the second embodiment.

In the gaming machine 13 according to the third embodiment of the invention, the game control unit 100B determines target illumination colors or patterns of each sectorial region of the surface of the wheel 9B, depending on which symbol types symbols 9SA, 9SB, 9SC illuminated with different colors or patterns in the sectorial regions are to be dealt with as. The game control unit 100B further causes the lighting control unit 102 and the lighting driver unit 93 to control driving currents Id flowing in series of LCDs 97A-97D of the lighting units 97, thereby achieving the target illumination colors or patterns of the symbols 9SA, 9SB, 9SC. On the other hand, the color check unit 94 monitors the levels of the driving currents Id, and generates an error signal ERR when detecting the level of any driving current Id falls outside a predetermined range L1-L2. In response to the error signal ERR, the lighting control unit 102 informs the game control unit 100B of an error in any lighting unit 97. This enables the game control unit 100B to immediately detect an illumination color or pattern in the symbol 9SA, 9SB, 5SC deviating from the target one. The game control unit 100B then takes appropriate steps to inform a player and/or an attendant of the error.

Thus, the gaming machine 13 can immediately detect inconsistency between a type and an actual illumination color/pattern of each symbol 9SA, 9SB, 9SC, thereby ensuring exact consistency therebetween under normal conditions. Therefore, the gaming machine 13 can increase the variety of symbols by using various illumination colors/patterns with a sufficiently high level of reliability about consistency between illumination colors/patterns and symbol types.

### The Fourth Embodiment

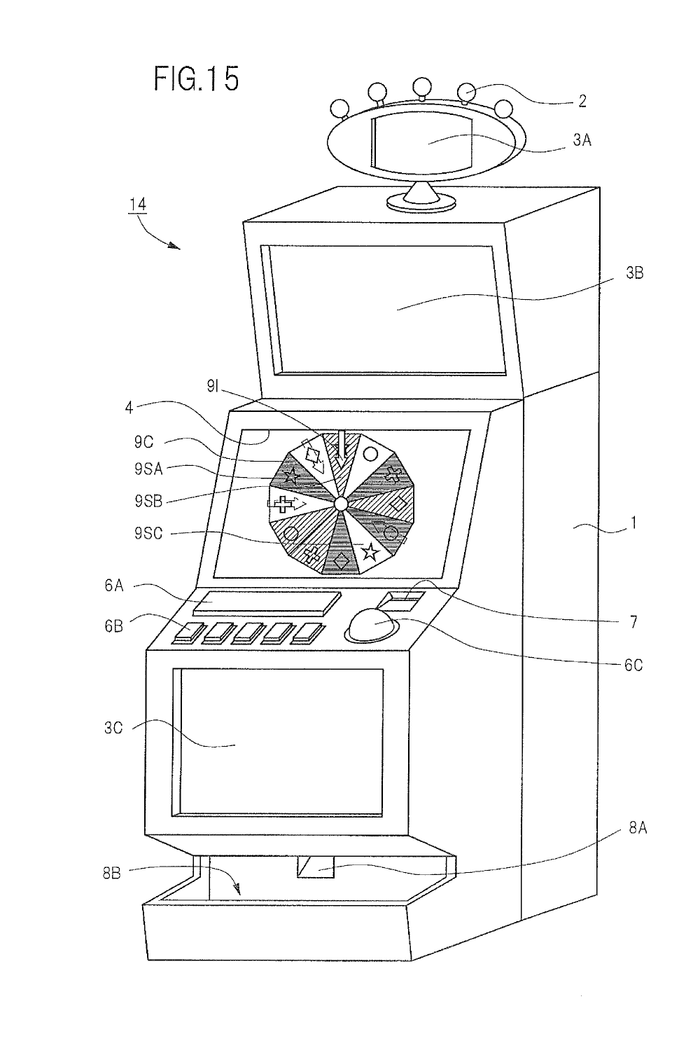

Referring to FIG. 15, a gaming machine 14 according to the fourth embodiment of the invention is preferably a wheel-of-chance machine. Like the gaming machine 12 of the second embodiment shown in FIG. 7, this gaming machine 14 shown in FIG. 15 includes a wheel of chance 9C and an indicator member 9I, as well as a cabinet 1, lamps 2, display devices 3A, 3B, 3C, a touch panel 6A, operation buttons 6B, a spin button 6C, a coin/bill slot 7, a coin chute 8A, and a coin tray 8B, as components visible from the exterior.

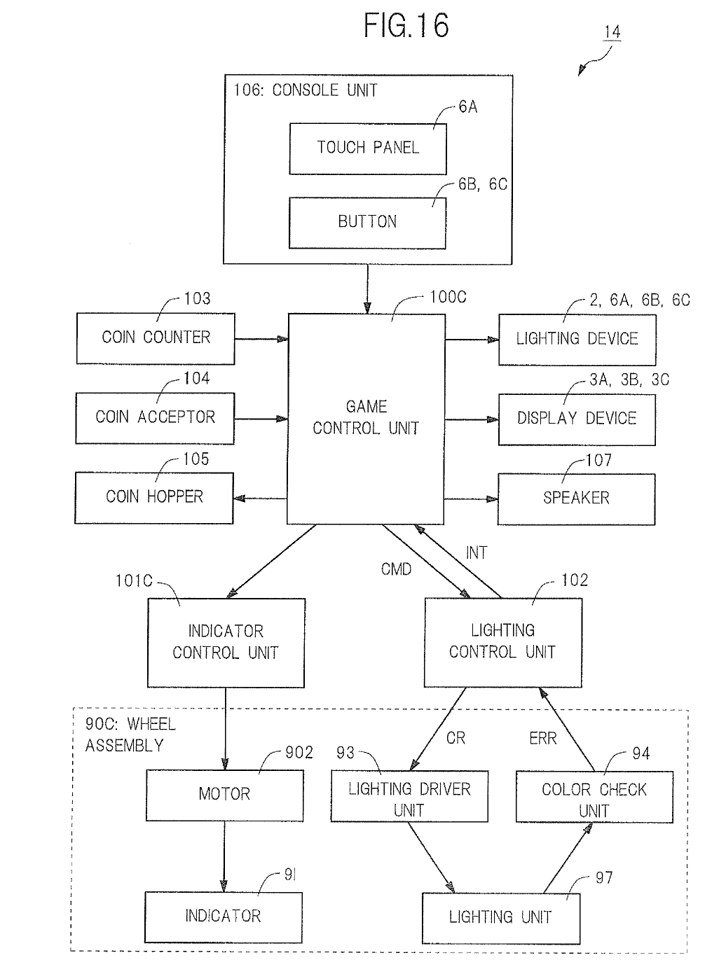

Referring to FIG. 16, the gaming machine 14 of the fourth embodiment also includes an indicator control unit 101C and a wheel assembly 90C as a component mounted inside the cabinet 1 and invisible from the exterior, as well as a game control unit 100C, a lighting control unit 102, a coin counter 103, a coin acceptor 104, a coin hopper 105, a console unit 106, and a speaker 107. The wheel assembly 90C includes a motor 902 as well as the indicator member 9I, a lighting driver unit 93, a color check unit 94, and a lighting unit 97.

As compared to FIGS. 7 and 8, FIGS. 15 and 16 show similar components marked with the same reference numbers, except for the game control unit 100C, the indicator control unit 101C, and the wheel assembly 90C. A description of the similar components can be found above in the description of the first or second embodiment.

The wheel 9C of the fourth embodiment is fixed in a similar manner to the wheel 9A of the second embodiment. Instead of the wheel 9C, the indicator member 9I is rotatably mounted around the periphery of the wheel 9C. The motor 902 is preferably a stepping motor having a shaft coupled to the indicator member 9I. The motor 902 controls the position and speed of the indicator member 9I around the wheel 9C under control of the indicator control unit 101C.

Referring to FIG. 16, the game control unit 100C, the indicator control unit 101C, and the lighting control unit 102 are preferably comprised of a microcomputer including a CPU, a ROM, and a RAM. Alternatively, the three control units 100C, 101C, and 102 may be separately composed of distinct pieces of hardware.

The indicator control unit 101C controls the motor 902 under control of the game control unit 100C, thereby rotating the indicator member 9I at a desired speed and stopping it at a desired position.

The game control unit 100C stores a game program. When receiving a cue for the start of a game from a player through the console unit 106, e.g., when the player enters coins/bills into the coin/bill slot 7, the game control unit 100C invokes the game program. After that, the game control unit 100C conducts the game according to the executed game program. In particular, the game control unit 100C controls other components installed on the gaming machine 14, depending on the game status as follows.

When a player enters coins/bills into the coin/bill slot 7, the game control unit 100C detects and accepts the coins/bills through the console unit 106, then increasing credits available to the player by the count provided by the coin counter 103. In parallel with that, the game control unit 100C starts to produce visual and sound effects by using the lighting devices 2, 6A, 6B, 6C, the display devices 3A, 3B, 3C, and the speaker 107.

When the player places a bet by using the touch panel 6A and/or the buttons 6B, the game control unit 100C identifies the bet accepted by the console unit 106, then decreasing the available credits by the amount of the bet. The game control unit 100C further displays the amounts of the bet and the number of available credits on the display devices 3A, 3B, and/or 3C.

When the console unit 106 detects that the player has pushed the spin button 6C, the game control unit 100C then causes the indicator control unit 101C to command the motor 902 to rotate the indicator member 9I. In synchronization with the spin, the game control unit 100C provides the lighting control unit 102 with commands CMD to control the lighting driver unit 93 of the wheel assembly 90C to cause the lighting units 97 to illuminate the respective sectorial regions on the wheel 9C with various colors/patterns of light.

On the other hand, the game control unit 100C randomly determines which sectorial region the indicator member 9I is to be stopped at, i.e., which symbols is to be pointed by the stopped indicator member 9I. In addition, the game control unit 100C randomly determines which color/pattern the sectorial region to be pointed by the indicator member 9I is to be illuminated with. Thus, the game control unit 100C randomly determines which types of symbol are to be pointed by the indicator member 9I. Depending on the type of symbol and the amount of the bet, the game control unit 100C further determines whether or not to provide an award to the player and which type of award, e.g. a payout or a right of playing a bonus game, to be provided to the player.

After a predetermined time has elapsed from the start of the spin, the game control unit 100C causes the indicator control unit 101C to stop the indicator member 9I at the predetermined position. If the type of a symbol pointed by the stopped indicator member 9I represents an amount of a payout, the game control unit 100C will increase the available credits by the payout, or causes the coin hopper 105 to discharge the coins equivalent to the payouts. If the type of a symbol pointed by the stopped indicator member 9I represents a right of playing a bonus game, the game control unit 100C will start a bonus round. In addition, the game control unit 100C controls the lighting devices 2, 6A, 6B, 6C, the display devices 3A, 3B, 3C, and the speaker 107 to produce visual and sound effects to announce the winning of the payout or the start of the bonus round.

Like the game control unit 100A of the second embodiment, the game control unit 100C also predetermines and stores a relationship between illumination colors/patterns and symbol types, thereby dealing with a single symbol as a different type depending on an illumination color or pattern. Accordingly, the color check unit 94 is used to quickly detect inconsistency between actual colors/patterns of illuminated symbols and symbol types to be visible on the wheel 9C. A description of functions of the color check unit 94 can be found above in the description of the second embodiment.

In the gaming machine 14 according to the fourth embodiment of the invention, the game control unit 100C determines target illumination colors or patterns of each sectorial region of the surface of the wheel 9C, depending on which symbol types symbols 9SA, 9SB, 9SC illuminated with different colors or patterns in the sectorial regions are to be dealt with as. The game control unit 100C further causes the lighting control unit 102 and the lighting driver unit 93 to control driving currents Id flowing in series of LCDs 97A-97D of the lighting units 97, thereby achieving the target illumination colors or patterns of the symbols 9SA, 9SB, 9SC. On the other hand, the color check unit 94 monitors the levels of the driving currents Id, and generates an error signal ERR when detecting the level of any driving current Id falls outside a predetermined range L1-L2. In response to the error signal ERR, the lighting control unit 102 informs the game control unit 100C of an error in any lighting unit 97. This enables the game control unit 100C to immediately detect an illumination color or pattern in the symbol 9SA, 9SB, 5SC deviating from the target one. The game control unit 100C then takes appropriate steps to inform a player and/or an attendant of the error.

Thus, the gaming machine 14 can immediately detect inconsistency between a type and an actual illumination color/pattern of each symbol 9SA, 9SB, 9SC, thereby ensuring exact consistency therebetween under normal conditions. Therefore, the gaming machine 14 can increase the variety of symbols by using various illumination colors/patterns with a sufficiently high level of reliability about consistency between illumination colors/patterns and symbol types.

The devices according to the above-described embodiments of the invention are installed in gaming machines. However, this never limits the use of devices according to the invention to gaming machines. The devices can be installed in other various systems to be used in control of various types of lighting devices, thereby facilitating accurate checks for consistency between a target and actual color or pattern of light at sufficiently high speed. If the consistency is lost, the devices can use an error signal to immediately notify the systems of the loss of the consistency.

### GENERAL INTERPRETATION OF TERMS

In understanding the scope of the present invention, the term “configured” as used herein to describe a component, section or part of a device includes hardware and/or software that is constricted and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

1. A device comprising
a lighting driver unit configured to control flow of a driving current in an external lighting unit configured to emit a colored ray of light in response to the driving current; and
a color check unit configured to monitor the level of the driving current and generate an error signal in response to detection of levels of the driving current outside a predetermined range.

2. The device according to claim 1, wherein the lighting driver unit is configured to control intensity of the colored ray by pulse modulation of the driving current.

3. The device according to claim 1, wherein the lighting driver unit comprises a switching device configured to conduct or cut off the driving current; and
the lighting driver unit is configured to turn on or off the switching device in response to a control signal.

4. A device comprising
a lighting unit configured to emit a colored ray of light in response to a driving current;
a lighting driver unit configured to control flow of the driving current to the lighting unit; and
a color check unit configured to monitor the level of the driving current and generate an error signal in response to detection of levels of the driving current outside a predetermined range.

5. The device according to claim 4, wherein the lighting unit comprises an LED selected from a group consisting of red, green, and blue LEDs.

6. The device according to claim 4 comprising a member including a surface having a region placed at a visible position and illuminated by the lighting unit.

7. The device according to claim 6 comprising
a motor including a shaft, wherein
the member comprises a reel configured to be rotatably coupled to the shaft; and
the surface of the member is wrapped around a circumference of the reel, including a a region illuminated by the lighting unit and a series of symbols displayed and arranged thereon along the circumference of the reel.

8. The device according to claim 7, wherein the color check unit comprises
a current detector unit configured to check whether or not the level of the driving current falls within the predetermined range;
a comparator unit configured to check whether or not timing consistency is maintained between a control signal and the output of the current detector unit, the control signal causing the lighting driver unit to control flow of the driving current in the lighting unit; and
an error notification unit configured to generate the error signal when the output of the comparator unit indicates timing inconsistency between the control signal and the output of the current detector unit.

9. The device according to claim 6 wherein the member comprising
a wheel of chance;
the surface of the member includes a plurality of the regions arranged around an axis of the wheel;
a plurality of the lighting units each illuminate one of the regions; and
the color check unit is configured to monitor a level of a driving current flowing in each of the lighting units, and generate the error signal in response to detection of levels of the driving current outside a predetermined range.

10. The device according to claim 9, wherein the color check unit comprises
a plurality of current detector units each configured to check whether or not a level of a driving current flowing in one of the lighting units falls within a predetermined range;
a plurality of comparator units each configured to check whether or not timing consistency is maintained between a control signal and an output of one of the current detector units, the control signal causing the lighting driver unit to control flow of a driving current in each of the lighting units;
an OR gate unit configured to perform a logical OR operation between outputs of the comparator units; and
an error notification unit configured to generate the error signal when an output of the OR gate unit indicates timing inconsistency between the control signal and an output of one of the current detector units.

11. The device according to claim 9 comprising a motor including a shaft to which the wheel is configured to be rotatably coupled.

12. The device according to claim 9 comprising
a motor including a shaft, and
an indicator member configured to be rotatably coupled to the shaft, changing a position along a circumference of the wheel.

13. A gaming machine comprising
a device comprising
a member comprising a surface including a region placed at a visible position;
a lighting unit configured to illuminate the region of the surface of the member with a colored ray of light in response to a driving current;
a lighting driver unit configured to control flow of the driving current in the lighting unit in response to a control signal; and
a color check unit configured to monitor the level of the driving current and generate an error signal in response to detection of levels outside a predetermined range;
a game control unit configured to conduct a game by changing an illumination color or pattern of the region of the surface of the member; and
a lighting control unit configured to provide the lighting driver unit with the control signal under control of the game control unit, and if receiving the error signal from the color check unit, inform the game control unit of an error in the lighting unit.

14. The gaming machine according to claim 13 comprising a reel control unit, wherein the device comprises a motor including a shaft;
the member comprises a reel configured to be rotatably coupled to the shaft;
the surface of the member is wrapped around a circumference of the reel, including a series of symbols displayed and arranged thereon along the circumference of the reel; and
the reel control unit is configured to command the motor to spin the reel and stop the reel at a predetermined position under control of the game control unit.

15. The gaming machine according to claim 13 wherein the member comprises a wheel of chance;
the surface of the member includes a plurality of the regions arranged around an axis of the wheel;
a plurality of the lighting units each illuminate one of the regions of the surface with a colored ray of light in response to a driving current;
the color check unit is configured to monitor a level of a driving current flowing in each of the lighting units, and generate the error signal in response to detection of levels of a driving current flowing in one of the lighting units falls outside a predetermined range; and
the lighting control unit is configured to cause the lighting driver unit to control each of the lighting units to change brightness or a color in one of the regions of the surface under control of the game control unit.

16. The gaming machine according to claim 13 comprising a wheel control unit, wherein the device comprises a motor including a shaft;
the member comprises a wheel of chance configured to be rotatably coupled to the shaft;
the surface of the member includes a plurality of the regions arranged around an axis of the wheel;
a plurality of the lighting units each illuminate one of the regions of the surface with a colored ray of light in response to a driving current;
the color check unit is configured to monitor a level of a driving current flowing in each of the lighting units, and generate the error signal in response to detection of levels of a driving current flowing in one of the lighting units falls outside a predetermined range; and
the wheel control unit is configured to command the motor to spin the wheel and stop the wheel at a predetermined position under control of the game control unit.

17. The gaming machine according to claim 13 comprising an indicator control unit, wherein the device comprises a motor including a shaft;
the member comprises a wheel of chance and an indicator member configured to be rotatably coupled to the shaft and allowed to change a position along a circumference of the wheel;
the surface of the member includes a plurality of the regions arranged around an axis of the wheel;
a plurality of the lighting units each illuminate one of the regions of the surface with a colored ray of light in response to a driving current;
the color check unit is configured to monitor a level of a driving current flowing in each of the lighting units, and generate the error signal in response to detection of levels of a driving current flowing in one of the lighting units falls outside a predetermined range; and
the indicator control unit is configured to command the motor to spin the indicator member and stop the indicator member at a predetermined position under control of the game control unit.
